(19) United States
(12) Patent Application Publication
(10) Pub. No.: US 2026/0246571 A1
(43) Pub. Date: Aug. 20, 2026

(54) IN-SEQUENCE RECEPTION OF MULTIPLE PDU SETS IN THE DOWNLINK

(71) Applicant: InterDigital Patent Holdings, Inc., Wilmington, DE (US)

(72) Inventors: Jaya Rao, Montreal (CA); Tejaswinee Lutchoomun, Montreal (CA); Srinivas Gudumasu, Montreal (CA); Michael Starsinic, Newtown, PA (US)

(73) Assignee: InterDigital Patent Holdings, Inc., Wilmington, DE (US)

(21) Appl. No.: 19/152,598

(22) PCT Filed: Feb. 13, 2024
(86) PCT No.: PCT/US2024/015553

§ 371 Date: Jul. 31, 2025

Related U.S. Application Data
(60) Provisional application No. 63/445,465, filed on Feb. 14, 2023.

(51) Int. Cl. H04L 1/1829

(52) U.S. Cl. CPC H04L 1/1829

(57) ABSTRACT

A wireless transmit/receive unit (WTRU) may be configured to receive configuration information indicating a re-ordering timer duration, receive a first plurality of packet data units (PDUs) of a first PDU set, determine an order of the first plurality of PDUs based on respective sequence numbers (SNs) associated with the first plurality of PDUs, and/or receive a second plurality of PDUs of a second PDU set. On condition that there is a SN gap between a last PDU of the first PDU set and a first PDU of the second PDU set, the WTRU may be further configured to suspend re-ordering of the first plurality of PDUs, set a re-ordering timer to the indicated re-ordering timer duration and start the re-ordering timer, and/or receive a set of one or more additional PDUs while the re-ordering timer is running.

### CROSS-REFERENCE TO RELATED APPLICATIONS

This application claims the benefit of U.S. Provisional Application No. 63/445,465 filed on Feb. 14, 2023, the entire contents of which is incorporated herein by reference.

### BACKGROUND

The term extended Reality (XR) may be an umbrella term for different types of immersive experiences including Virtual Reality (VR), Augmented Reality (AR) and Mixed Reality (MR) and the realities interpolated among them. VR is a rendered version of a delivered visual and audio scene. The rendering may be designed to mimic the visual (e.g. stereoscopic 3D) and audio sensory stimuli of the real world as naturally as possible to an observer or user as they move within the limits defined by the application. AR is a technology when a user is provided with additional information or artificially generated objects/items or content overlaid upon their current environment. MR is an advanced form of AR where some virtual elements are inserted into the physical scene with the intent to provide the illusion that these elements are part of the real scene. XR may include to one or more (e.g., all) real-and-virtual combined environments and human-machine interactions generated by computer technology and wearables.

The notion of immersion in the context of XR applications/services may refer to the sense of being surrounded by the virtual environment as well as providing the feeling of being physically and spatially located in the virtual environment. The levels of virtuality may range from partial sensory inputs to fully immersive multi-sensory inputs leading to a virtual reality practically indiscernible from actual reality.

### SUMMARY

A wireless transmit/receive unit (WTRU) may include one or more processors. The WTRU may be configured to receive configuration information indicating a re-ordering timer duration. The WTRU may be configured to receive a first plurality of packet data units (PDUs) of a first PDU set. The WTRU may be configured to determine an order of the first plurality of PDUs based on respective sequence numbers (SNs) associated with the first plurality of PDUs. The WTRU may be configured to receive a second plurality of PDUs of a second PDU set. On condition that there is a SN gap between a last received PDU of the first PDU set and a first received PDU of the second PDU set, the WTRU may be further configured to suspend re-ordering of the first plurality of PDUs, set a re-ordering timer to the indicated re-ordering timer duration and start the re-ordering timer, and/or receive a set of one or more additional PDUs while the re-ordering timer is running.

On condition that the set of one or more additional PDUs do not correspond to PDUs associated with the SN gap, the WTRU may be configured to re-order the second plurality of PDUs and the set of one or more additional PDUs based on respective SNs. The WTRU may be configured to deliver the re-ordered second plurality of PDUs and the set of one or more additional PDUs to higher layers.

On condition that the set of one or more additional PDUs correspond to PDUs associated with the SN gap, the WRTU may be configured to resume re-ordering of the first plurality of PDUs and the set of one or more additional PDUs based on respective SNs. The WTRU may be configured to deliver the re-ordered first plurality of PDUs and the set of one or more additional PDUs to higher layers.

The WTRU may be further configured to transmit a status indication on PDU set ordering status to network. The PDU set ordering status may include acknowledgement (ACK) and/or negative acknowledgement (NACK).

The configuration information indicating the re-ordering timer duration may include one or more threshold values associated with the re-ordering timer duration. The order of the first plurality of PDUs may be an ascending order of SNs.

The WTRU may be further configured to start one or more timers upon receiving the first plurality of PDUs of the first PDU set. The one or more timers may start on condition that a first PDU of the first plurality of PDUs is received and/or the re-ordering of the first plurality of PDUs is started. The one or more timers may stop and/or reset on condition that the last PDU of the first plurality of PDUs is received and/or the re-ordering of the first plurality of PDUs is completed.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIGS. 2A and 2B illustrate example forwarding configurations at access stratum (AS) layers for in-sequence data delivery.

### DETAILED DESCRIPTION

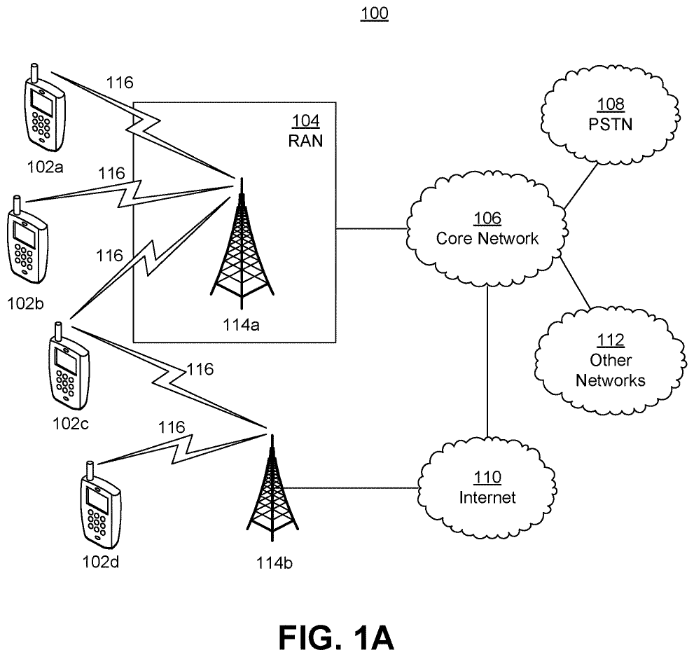

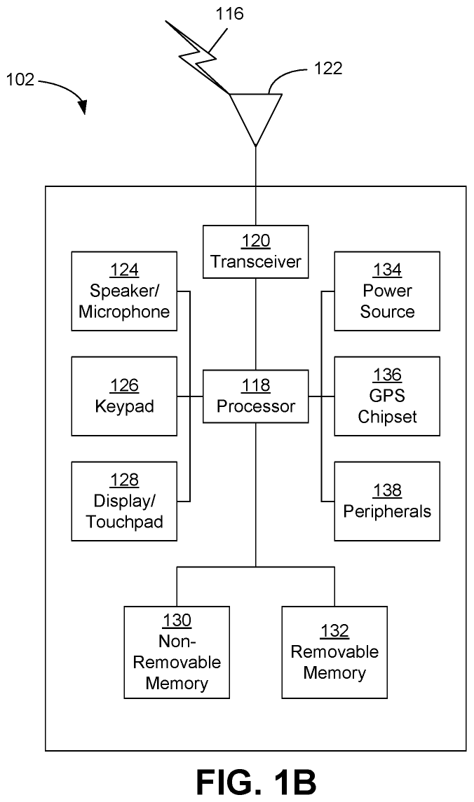

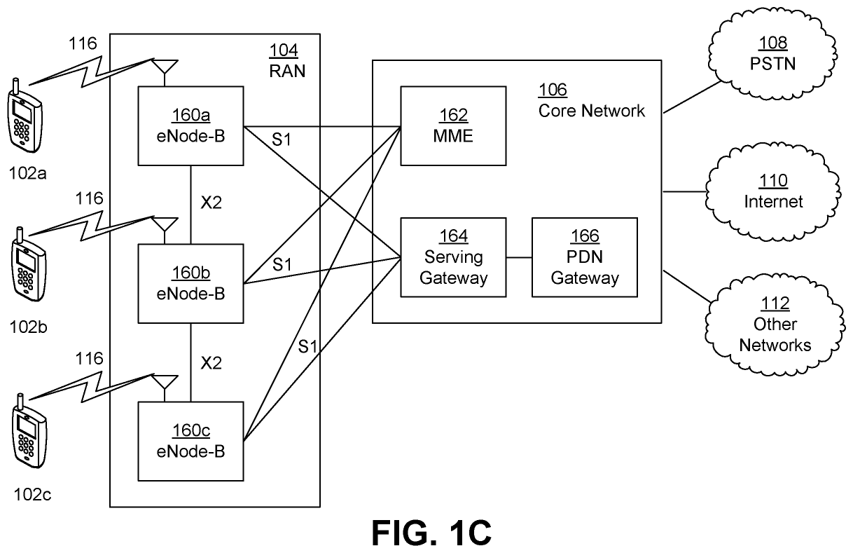

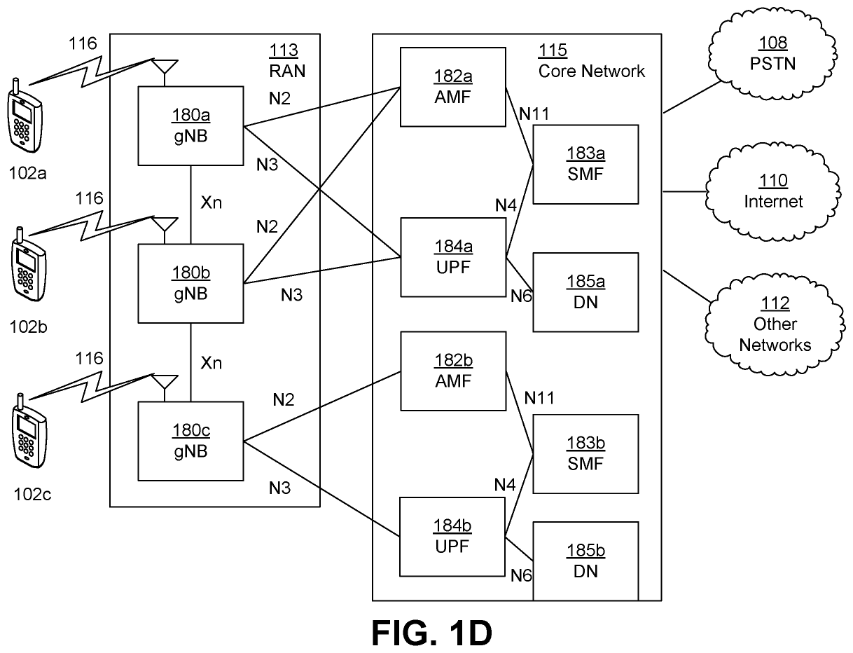

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUS 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUS 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In extended reality (XR) applications, a wireless transmit/receive unit (WTRU) may transmit XR traffic including one or more protocol data units (PDUs) and/or PDU sets in uplink (UL) (e.g., pose, gesture, video data) and/or receive XR traffic in downlink (DL) (e.g., video, audio, haptics). The traffic may be transmitted and/or received periodically or aperiodically in one or more data flows (e.g., QoS flows). During UL transmissions, XR traffic may arrive from application layer at WTRU at different time instances and/or with different traffic attributes (e.g., variable payload sizes per PDU set, variable per-PDU set level importance). For ensuring that the Quality of Service (QoS) (e.g., PDU set delay bound (PSDB), PDU set error rate (PSER)) is met may be important for prioritization, multiplexing and scheduling is done on timely basis considering the PDU set attributes. For ensuring Quality of Experience (QoE), the PDUs within a PDU set or different PDU sets generated at the transmitting side of the application may be expected to be delivered to the receiving side of the application within QoS (e.g., PSDB) and in-sequence.

In XR traffic, the different PDUs or PDU sets may contribute to different user experiences (e.g., QoE). For example, the PDUs/PDU sets may be associated with different importance and/or priority values from application layer perspective. For another example, the one or more PDU sets transmitted sequentially in time domain may be inter-dependent with each other in different ways. In order words, unlike the existing QoS framework where one or more (e.g., all) PDUs and/or PDU sets in a flow are provided with the same forwarding treatment by assuming equal importance/priority, the PDUs and/or PDU sets in a data burst for XR traffic may need to be differentiated and handled differently QoS-wise at the lower layers, irrespective of whether the PDUs and/or PDU sets are in one or more QoS flows, during scheduling and transmissions in UL and/or DL.

The inter-dependencies between the PDUs and/or PDU sets in a single or multiple QoS flows may result in different challenges for meeting the QoS at PDU set level during transmission in UL and DL. For example, solutions that ensure proper mapping of the inter-dependent PDU sets or data bursts received from higher layers in WTRU to one or more configured data radio bearer (DRBs) and/or logical channels (LCHs) such that suitable ordering of PDUs and/or PDU sets and forwarding treatment for QoS may be provided during data transmissions are unknown.

One or more packet data convergence protocol (PDCP) entities in the PDCP sublayer may support maintenance of PDCP sequence numbers (SNs), reordering and in-order delivery of PDUs. The PDCP entities may perform retransmission or transmission of one or more (e.g., all) the PDCP service data units (SDUs) already associated with PDCP SNs in ascending order of the COUNT values associated to the PDCP SDU. In-sequence/in-order delivery of PDUs in PDU set or in-sequence delivery of PDU sets may not be supported.

In-sequence delivery of PDUs may be supported at transmitting and receiving PDCP entities based on assignment of COUNTs (e.g., hyper frame number (HFNs), and SNs to each PDU) and the triggering of a reordering timer when an SN gap is detected at the receiving PDCP entity. Directly extending the legacy mechanism for supporting in-sequence delivery of PDUs and/or PDU sets may result in several issues. For example, the issue may include resource usage inefficiency (e.g., if all PDU sets are mapped to the same DRB/PDCP entity, a PDU set with low importance and/or priority is provided with the same level of prioritization, and resources as a PDU set with high importance/priority). For another example, the issue may include conflict and/or tradeoff with the differentiated QoS procedure at lower layers (e.g., prioritizing at medium access control (MAC) sublayer the high importance PDU sets before the low importance PDU sets during transmission may result in out-of-order delivery).

Leaving in-sequence delivery and reordering of PDU sets entirely to application (e.g., via the use of a de-jitter buffer at application) may come at the expense of reduced PSDB for data delivery at WTRU and network. In this regard, the key challenge to be addressed in the context of XR traffic (e.g., inter-dependent PDUs) may be how to ensure in-sequence delivery of PDU sets when supporting differentiated QoS (e.g., prioritization) during data transmissions.

A network may include any of a base station (e.g., gNodeB (gNB), transmission/reception point (TRP), radio access network (RAN) node, access node), core network function (e.g., AMF, SMF, policy control function (PCF), network exposure function (NEF)) and application function (e.g., edge server function, remote server function).

Flows may correspond to one or more of QoS flows or data flows (e.g., flow of data including one or more PDUs, PDU sets or data bursts, which may be associated with one or more QoS requirements, e.g., latency, data rate, reliability, round trip time (RTT) latency). Different flows, possibly originating from a common application/experience source and/or intended to a common destination device/WTRU or group of associated devices/WTRU may be referred to associated flows or correlated flows.

A data unit may refer to one of one or more frames (e.g., media/video/audio frame or slice/segment), PDUs, PDU sets, data bursts, group of frames/PDUs/PDU-sets/data bursts.

a QoE metric and measurement may correspond to one of application and/or higher layer metrics and measurements, which may be directly or indirectly detectable/visible at the WTRU and/or application function. For example, the QoE metrics and measurements may or may not be directly visible/detectable at the base station. The QoE metrics and measurements may be determined/performed as a function of QoS metrics/parameters (e.g., latency, data rate, reliability, RTT/motion-to-photon (MTP) latency).

Forwarding configuration may correspond to one of radio bearers (e.g., DRBs and/or signaling radio bearers (SRBs), LCHs), logical channel groups (LCGs), configuration parameters in the individual layers within the AS protocol stack (e.g., service data adaptation control (SDAP), PDCP, radio link control (RLC), MAC, physical layer (PHY), other new protocol layers), configuration to be applied for assigning COUNT/SNs for PDUs/PDU sets/data bursts and for ensuring in-sequence delivery of the PDUs within a PDU set or different PDU sets at transmit (Tx) and receive (Rx) PDCP entities, parameters associated with logical channel prioritization (LCP) (e.g., priority, prioritized bit rate (PBR), bucket size duration (BSD)), bandwidth parts (BWPs), carriers, radio links/interfaces (Uu links, sidelinks (SLs), and radio resources (e.g., set of one or more frequency/time/spatial resources such as symbols, slots, subcarriers, resource elements or beams). Radio resources may be associated with configurated grants (CG), dynamic grants (DG) and/or any other resource grants or grant free resources.

Mapping configuration may correspond to one of the parameters and/or configurations associated with mapping from one or more dataset. For example, the dataset may be one of Data units, PDUs, SDUs, PDU sets, data bursts, application data (e.g., application data unit (ADU) flows, or QoS flows (e.g., associated or non-associated). For example, the dataset may originate from one or more of application layer, higher layers, and/or network to one or more radio bearers (e.g., DRBs, SRBs), sublayers or entities (e.g., SDAP, new layer, PDCP, RLC, MAC, PHY), LCHs, carriers or component carriers (e.g., component carriers (CCs) in carrier aggregation (CA) configurations), bandwidth parts (BWPs), and radio links/interfaces (e.g., Uu link or sidelinks), which may be used for delivering the data/PDUs in UL direction or DL direction.

XR/application-aware data transmissions/receptions or XR/application-aware QoS handling, may correspond to one of the following properties. For example, the property may include attributes associated with PDU set, ADU or data burst. A PDU set (e.g., media unit, video frame) may comprise of one or more PDUs. The PDUs within the PDU set or PDU sets within a data burst may be inter-dependent with each other at the application layer and/or lower layers (e.g., access stratum (AS)-layers). For another example, the property may include a PDU set may be associated with PDU set-level QoS requirements (e.g., data rate, latency, error rate, reliability), which may be applicable for one or more (e.g., all) PDUs associated with a PDU set. The different PDUs in a PDU set may be associated with individual PDU-level QoS requirements. For another example, a data burst may refer to the data produced by the application in a short period of time, comprising PDUs from one or more PDU Sets. Such attributes, associations and inter-dependencies (e.g., intra-PDU set and/or inter-PDU set), including the start and/or end indication of a PDU set and/or data burst (e.g., via sequence number, start/end indication), start time and/or end time, duration, payload sizes, periodicity, importance/priority and QoS (e.g., PSDB) may be visible to the AS-layers (e.g., with associated IDs) and/or handled at the AS layers with the awareness of the association during data transmission in UL and reception in DL. For another example, application, high layer importance or priority may include the different PDUs in a PDU set or all PDUs in a PDU set. The different PDUs in a PDU set or all PDUs in a PDU set may be associated with different application/high layer importance/priority values. Such importance value may correspond to spatial importance (e.g., spatial position of the video frame whose data is carried by the PDU/PDU set, where PDUs and/or PDU set carrying field of view (FoV) spatial positions may be associated with higher spatial importance than non-FoV spatial positions) or temporal importance (e.g., time sequence of the video frame who data is carried by the PDU/PDU set, where PDUs/PDU sets carrying base video frames such as I-frame may be associated with higher temporal importance than differential video frames such as P-frame/B-frame). Such importance values may be visible to the AS layers (e.g., with associated IDs/markers/indications), possibly enabled by application awareness, during data transmission and reception. Another example may be QoS/data flow. The PDUs/PDU sets of an application may be encoded and delivered by the application to WTRU (in UL) or network (in DL) via one or more QoS/data flows. In this regard, the different QoS flows carrying the PDUs/PDU sets associated to an XR application/experience may be visible to the AS-layers (e.g., with associated IDs) and/or handled at the AS layers with the awareness of the association during data transmission and reception.

WTRU actions or WTRU behavior, possibly related to application actions and/or AS-layer actions for ensuring/supporting differentiated QoS, may correspond to one or more of a determination of metadata of application (e.g., XR application), a determination and/or a generation of application content, performing measurements and reporting, transmitting or forwarding of data or PDUs or PDU sets and handling QoS associated with PDUs and/or PDU sets, and/or transmitting or forwarding of information related to connectivity with network and/or other WTRUS.

Determining metadata may, for example, involve determining one or more of the FoV/visual/spatial perimeters, 2D/3D size, border, spatial attributes and boundaries of FoV, based on measurements in any spatial dimension. The spatial dimensions may include but not be limited to longitude, latitude, altitude, depth, roll, pitch, yaw in one more coordinate system (e.g., cartesian, spherical). For another example, determining metadata may involve determining the quality of the FoV content, for example, whether the FoV content is of high quality (which in the case of an image, may be quantified and assessed by the image resolution (e.g., number of density of megapixels)). In an example, the data in one or more PDUs, PDU sets or data bursts may associate with an FoV content. For another example, determining metadata may involve determining the importance and/or priority of the FoV content. The importance of the FoV content may associate with the spatial importance and/or temporal importance of content/data. For example, the spatial/temporal importance value may indicate the absolute or relative importance associated with the FoV content. The spatial importance may associate with one or more of segments, tiles, slices or positions of FoV in spatial dimension, for example. Temporal importance may be associated with one or more frames and/or subframes of FoV in time dimension, for example.

Determining application content may, for example, involve determining and/or capturing the one or more 2D/3D images and/or video frames. The 2D/3D images and/or video frames may be associated with a FoV boundary, perimeter or border as defined by the FoV metadata by the WTRU and/or node for itself and/or on behalf of another WTRU and/or node. For FoV content mapping, the WTRU may determine the images and/or video frames using visual sensors (e.g., 2D/3D camera, lidar), RF sensors (e.g., RF transceiver, RADAR), audio sensors (e.g., sonar), and the like. Herein, the mapping of FoV may also be referred to as sensing of FoV content or capturing of FoV content. For another example, determining of application content may also include recording and/or capturing of audio frames, either as part of the real environment or as part of an overlaid sound-track and/or audio file with the audio file originating from a source other than the current real environment being mapped.

The WTRU may, for example, perform measurements of positioning/spatial/pose (e.g., 6 or 3 degrees of freedom with respect to spatial dimensions (6DoF/3DoF) orientation, location/position), rate of motion/movement, and the like, of the user/WTRU and/or other objects (e.g., virtual or real) which the user may be interacting with. The WTRU may send and/or report the pose measurements to network periodically. The WTRU may send and/or report the pose measurements to network when detecting event triggers (e.g., change in pose measurements above/below a threshold). For another example, the WTRU may perform measurements of one or more of reference signals or channels (e.g., synchronization signal block (SSB), channel state information reference signal (CSI-RS), positioning reference signal (PRS), sidelink reference signal (RS)), global navigation satellite systems (GNSS) signals, unlicensed carriers, ultra-wideband signals, light detection and ranging (LIDAR) signals, visual signals, and the like. In another example, the WTRU may perform measurements of the radio link interfaces associated with the WTRU (e.g., Uu link, SL). For another example, the WTRU may trigger transmission and/or measurement of reference signals in other one or more WTRUs (e.g., via Uu link and/or sidelink). For another example, performing measurements and reporting may include sending of measurement report to network and/or another WTRU.

Data may, for example, include one or more of media frames, image frames, video frames, sensor data, and measurement data (e.g., pose measurements, link and/or channel measurements) determined by the WTRU, possibly for supporting an application, service, or network request associated with the WTRU. For another example, the WTRU may send and/or receive data, to/from one more destination including radio access network (RAN) node (e.g., gNB), CN function or entity, application function (e.g., hosted in WTRU or in network). For another example, the WTRU may perform splitting and/or merging of data and/or PDUs in one or more QoS flows into one or more forwarding configurations during transmission/receptions.

Sending capability information to network may include capability for supporting one or more traffic flows with different XR traffic patterns (e.g., periodic/aperiodic, PDU sets with variable payload sizes). For example, sending capability information to network may include capability for performing application layer measurements (e.g., QoE measurements, application buffer measurements, RTT measurements). For another example, sending capability information to network may also include capability for detecting changes to traffic patterns.

Sending inter-WTRU coordination capability information to network may include capability for supporting one or more interfaces, capability to coordinate and/or interact with other WTRUs/devices (e.g., via SL interfaces). For example, interacting with other WTRUs/devices may be co-located or non-co-located with the WTRU.

Receiving configuration may include receiving radio resource control (RRC) configuration from next generation node B (gNB) and/or non-access stratum layer (NAS-layer) configuration from CN.

Transmitting or forwarding of information related to connectivity with network and/or other WTRUs may include sending and/or receiving assistance data to/from network associated with traffic, QoS, scheduling, and the like, for supporting UL/DL transmissions. Transmitting or forwarding of information related to connectivity with network and/or other WTRUs may also include sending requests for radio resources and/or resource grants (e.g., dynamic grants, semi-static/configured grants).

The solutions at the WTRU for ensuring in-sequence delivery of data and meeting QoS when transmitting and/or receiving XR traffic may be discussed in detail as follow. The WTRU (in UL at SDAP) or network (in DL) may mark the data units, which includes one or more of PDUs, PDU sets or data bursts associated with XR traffic received in one or more QoS flows, with one or more of sequence numbers (SNs), QoS attributes, PDU set attributes, or timing and/or count information. For example, SNs may be marked on a per PDU, per PDU set or per data burst basis. The different types of SNs may include COUNTs, HFNs and PDU SNs. The QoS attributes may include QoS flow identifier (QFI), PSER, PSDB, or PDU set integrated handling indication (PSIHI) (e.g., flag indicating whether all PDUs of a PDU set are required to be delivered). The PDU set attributes may include type, total payload size (e.g., bits/bytes, number of PDUs), start PDU of a PDU set, or end PDU (end marker). The timestamp may indicate time when PDU is generated, remaining relay, or hop count (e.g., number of hops traversed or remaining).

The marking (e.g., in the PDU headers) on the data units may be used by the transmitting and/or receiving entities for performing certain actions associated with in-sequence delivery of the PDUs/PDU sets. For example, the performed certain actions associated with in-sequence delivery of the PDUs/PDU sets may include one or more of identification on whether there are SN gaps, generating status report (e.g., acknowledgement (ACK)/negative ACK (NACK) of received SNs) and triggering retransmissions.

The data units may include one or more of PDUs, PDU sets or data bursts associated with XR traffic, with the same or different QoS requirements/characteristics. The data units may be mapped to one or more forwarding configurations using mapping configurations. The different forwarding configurations may be configured to achieve and/or enforce different QoS when transmitting the PDUs/PDU sets. In an example, the PDU sets received from application in one or more QoS flows may be mapped using a mapping configuration (e.g., at SDAP, PDCP) to one or more forwarding configurations (e.g., DRBs with common/different PDCP entities or LHs with different configurations). The forwarding configurations may be associated and/or grouped for achieving and/or ensuring PDU set level QoS. Upon mapping, a set of parameters (e.g., priority, PBR, BSD) and/or configurations (e.g., LCP) may be applied at the forwarding configurations for achieving and/or enforcing PDU set-level or data burst-level QoS for the PDUs/PDU sets in the buffers associated with the forwarding configurations.

The PDUs of different PDU sets or PDU sets of a data burst, which are received from application and/or higher layers, may have different expected QoS to be satisfied during transmission. For example, based on the determination of the expected QoS for the PDUs/PDU sets received or to be received in QoS flows, the WTRU may apply certain mapping, buffer/queue management and adaptation mechanisms at one or more layers of the AS layer protocol stack (e.g., SDAP, PDCP, MAC). The expected QoS for the PDUs/PDU sets may be satisfied and/or delivered in-sequence to the network. For another example, the WTRU may expect to receive any of the PDU/PDU sets in DL from the network. Such mechanisms for satisfying the respective QoS and receiving the PDUs/PDU sets in-sequence may ensure QoE.

For satisfying QoS and ensuring in-sequence delivery of PDUs/PDU sets, the different layers in the forwarding configuration may be configured with different configuration parameters. For example, such configuration parameters may include support for reordering of the PDUs/PDU sets at PDCP, support for acknowledgement mode (AM)/unacknowledged mode (UM) in RLC, LCP rules/restrictions and associated LCH parameters (e.g., PBR, BSD, priority) at MAC and number of hybrid automatic repeat request (HARQ) transmissions. For ensuring in-sequence delivery, certain parameters may be configured and/or adapted at the PDCP (e.g., SN assignment, adjustment of SN space, robust header compression (ROHC), and MAC (e.g., LCH adaptation) sublayers.

The term expected QoS may be used to denote the expected margin of a certain QoS metric (e.g., latency, data rate, reliability) before the arrival of the data including any of PDUs, PDU sets, and/or data bursts. The term expected QoS may also be used to denote the expected margin of a certain QoS metric (e.g., latency, data rate, reliability) when the data is received at the WTRU (i.e. the QoS to be achieved/enforced when transmitting). In an example, the expected QoS may correspond to a time duration available at WTRU from reception (e.g., from higher layers) to successful delivery of the data over the radio link (e.g., Uu link or sidelink). In another example, the expected QoS may also correspond to the time-to-live (TTL) (e.g., maximum time available for buffering, processing and delivering) for an individual PDU, PDU set, or data. In this case, the expected QoS may be determined based on the indications and/or markers in the PDUs/PDU sets (e.g., QoS flow identifier (QFI), timestamps, PDU set ID, and the like, in the packet headers of the PDU/PDU sets) and/or based on usage of timers. For example, the usage of timers may be set when receiving the PDUs/PDU sets and reset/stopped at the expiry of a configured time duration. Similar mechanisms (e.g., based on indications/markers and/or timers) may be applied for changing between different mapping and/or forwarding configurations for ensuring expected QoS.

In some examples, the expected QoS may be stricter or relaxed than the default QoS metric applied associated with the PDUs/PDU sets. For example, if a PDU set arrives late at the WTRU, the importance value for the PDU set may be indicated to be high (e.g., above a threshold), or having experienced more delay and jitter at the application layer (e.g., due to encoder), the expected latency to be satisfied over the unique users (U)u link for the PDU set may be lower than the default PSDB that is typically used for sending the PDUs of the PDU set. Alternatively, if a PDU set arrives early or the importance value for the PDU is indicated to be low (e.g., below a threshold), the expected latency over the Uu link may be considered to be more relaxed than the PSDB, which is normally used for sending such PDUs.

In summary, the expected QoS may vary dynamically based on the QoS experienced during reception and/or importance/priority indications, where for a fixed QoS (e.g., packet delay budget (PDB), packet error rate (PER), PSDB, PSER) an increase/decrease in the expected QoS prior to reception may translate to decrease/increase in the expected QoS over the radio link (e.g., Uu link).

In one family of solutions, the WTRU may be configured to support transmission and/or receptions of data units including any of PDUs, PDU sets, and/or data bursts in one or more flows in UL and/or in DL. The transmission and/or receptions of data units may result in in-sequence delivery of the data units while meeting the QoS associated with the data units.

The WTRU may support the data transmissions and/receptions that results in in-sequence data delivery, and/or assist the network for ensuring in-sequence delivery during transmissions based on one or more of the configurations, the triggering events, the conditions/criteria received from network and/or application.

The WTRU may be configured with one or more conditions and/or configurations associated with in-sequence delivery during UL transmissions and/or DL receptions. The conditions and/or configurations may relate to or may reflect an expected QoS to the achieved for the data units during transmission to the network (in UL), reception at WTRU (in DL), or a change of such expected QoS.

A WTRU, based on the conditions and/or configurations, may be configured for mapping of the data units of XR traffic received from higher layers/application and/or updating one or more of the forwarding configurations, the parameters at the protocol stack including SDAP, PDCP, RLC, MAC, PHY and any new layers in the AS layers based on the detection of one or more configured triggering conditions, during data transmissions in UL and/or DL. For example, the actions associated with selective mapping may include that the WTRU may be configured to perform 1:1, N:1 or N:M mapping from one or more PDU sets to one or more forwarding configurations for enabling flexible utilization of radio bearers and resources while ensuring in-sequence delivery and/or satisfying QoS. For another example, the actions associated with selective mapping may include that the WTRU may be configured to ensure ordered delivery (e.g., order intended by the application/AS layers) when transmitting in UL and/or receiving in DL the PDUs, PDU sets, and data bursts. For another example, the actions associated with selective mapping may include that the WTRU may also be configured for performing discarding any of the PDUs, PDU sets, or data bursts that are unable to satisfy the associated QoS requirements, possibly based on the intra/inter-PDU set dependency information.

A WTRU, based on the conditions and/or configurations, may be configured to perform measurements and/or reporting of XR traffic to be transmitted in UL and/or received in DL at any of the AS layers and/or application layers. The WTRU may be configured to transmit any of status reports/indications of the measurements performed by WTRU on the XR traffic, possibly periodically and/or when detecting any triggering conditions.

The WTRU may transmit assistance/status info associated in-sequence delivery of data units to network. For example, the WTRU may send information associated with any of XR traffic (e.g., association of PDUs to PDU sets, association/dependency between PDU sets in one or more data bursts) to network, possibly for enabling the network to have awareness of the traffic characteristics. The WTRU actions for ensuring in-sequence delivery during transmission/reception of XR traffic.

The information associated with XR traffic/application may be sent by the WTRU to network. The information may include one or more message types. For example, the message types may include capability information, assistance information, preferred/desired configuration information (e.g., preferred forwarding and/or resource), configurations/parameters to apply in UL/DL, preferred mode for in-sequence delivery), status information/indication (e.g., associated with any of AS-layers), measurement/status reports (e.g., pending data in buffer, remaining delay, ACK/NACK status), or request/response messages (e.g., request for activation/deactivation of a configuration or set of parameters, request for resources).

The information may be sent by the WTRU in various methods. The method may include sending periodically (e.g., using one or more configured periodicity values), sending aperiodically (e.g., when detecting triggering events/conditions described herein or as an update message when detecting a change in information sent previously) and/or on a semi-persistent base (e.g., sent with a periodicity value over a time window/duration).

In an example, the WTRU may switch between a first periodicity value and a second periodicity value for sending information. The WTRU's switch may be based on the type of event detected (e.g., change in type of PDU set to be transmitted in UL, buffer occupancy delay is greater than a threshold value). In another example, the WTRU may change between sending information periodically and aperiodically based on whether any change and/or amount of change is determined in the information to be reported.

The WTRU may send the information/indications to network via one or more of message types. The message types may include RRC signaling and/or messages (e.g., via SRB1, SRB2, SRB3, SRB4), control PDUs associated with any of the AS layers (e.g., SDAP control PDU, PDCP control PDU), UL MAC CE (e.g., new MAC CE, regular buffer status report (BSR), periodic BSR, padding BSR, enhanced BSR, pre-emptive BSR, elastic BSR which may be scalable/adjustable by sending subsequent indications, possibly without cancelling an earlier BSR), uplink control information (UCI) (e.g., single bit SR, multi-bit SR, feedback, ACK/NACK, channel state information (CSI) report), Physical Uplink Control Channel (PUCCH), Physical Uplink Control Shared Channel (PUSCH), non-AS (NAS) layer signaling (e.g., PDU session related messages), or application layer signaling/messages.

The information sent by the WTRU to network, in any of the message types, may include a combination of one or more of the identifiers/IDs, the priority of applications/services supported by WTRU, the data flows associated with the application, the devices associated with the application, the data/traffic types associated with the data flows per-application, the traffic characteristics and/or parameters associated with any of QoS flows, PDU set, and data burst per-application, the buffer info at application layers/higher layers/AS layers, the QoS requirements or expected QoS associated with the date, the capability information associated with connectivity, the capability information associated with WTRU actions/behavior, the preferred/desired configuration information, the information on updated forwarding configurations applied at WTRU, the indication for activating and/or deactivating configurations, and/or the measurements related to application and/or AS layer.

The WTRU may send one or more IDs and/or indexes. The IDs and/or indexes may include IDs associated with application (e.g., application ID, service ID, session ID, application configuration ID), group ID (e.g., associated with group of QoS flows, group of forwarding configurations, group of devices/WTRUs), IDs of individual QoS flows, mapping configurations, forwarding configurations, data unit types/message IDs and/or SNs (e.g., data burst ID, PDU set ID, PDU ID), and/or association ID (e.g., ID or SNs indicating the association and/or dependency between one or more PDUs, PDU sets, data bursts, flows).

For example, the WTRU may send IDs of the applications/services supported and/or info on the relative/absolute priority values associated with the supported applications.

For example, the WTRU may send the number and/or IDs associated with the data/QoS flows supported per-application. For another example, the WTRU may also send info on the relative/absolute priority values associated with the data/QoS flows of the different applications supported.

For example, the WTRU may send the number and/or IDs associated with the devices supported and/or the association of the devices per-application.

For example, the WTRU may send information on different data/QoS flows associated with an application, where the data type may include video data (e.g., I-frame data, P-frame data, B-frame data), red green blue-depth (RGB-D) data, 360 degrees video data, haptics data, pose/positioning data, audio data, and the like.

For example, the WTRU may send information on traffic characteristics/patterns of the different QoS flows, including whether the data is periodic, aperiodic, semi-persistent, quasi-periodic, and the like. The traffic characteristics may include the one or more periodicity values of the flow. For another example, the WTRU may send information on the size of PDU set, number of PDUs expected per PDU set in one or more flows per-application. The information of size of PDU set or number of PDUs per PDU set may also include statistical/distribution info such as mean, minimum, maximum, and/or standard deviation values. The information related to PDU set may include indication of start/first and/or end/last PDU of PDU set, and indication of the association/dependency of the PDUs in a PDU set (e.g., ID of PDU set, importance/priority value). For another example, the WTRU may send information on data bursts in one or more QoS flows, including the number of PDU sets (e.g., instantaneous, mean, maximum, minimum), payload size of data burst in units of bits/bytes (e.g., instantaneous, mean, maximum, minimum), periodicity, importance/priority, start and end indication of a data burst (e.g., ID of first PDU/PDU set, ID of last PDU/PDU set), and dependency info within data burst and across multiple data bursts (e.g., indicating whether PDU sets in one or more data bursts are dependent). For another example, the WTRU may send information related to the jitter in UL and/or in DL. The jitter info which may be sent on a per flow, per-PDU set or per PDU basis, may include the range, mean, maximum and minimum value. For another example, the WTRU may send information on the importance/priority of any of the data units (e.g., PDUs, PDU sets, data bursts) to be transmitted/received in UL/DL. For another example, the WTRU may send indications when detecting any changes to the UL/DL traffic patterns (e.g., changes to periodicity, changes to mean payload sizes, changes to jitter range). For another example, the WTRU may send info on prediction of traffic pattern in UL and/or DL for upcoming data (e.g., timing info indicating the time slot when the data is expected to arrive, size, importance of data to be received, uncertainty and/or confidence level of prediction).

For example, the WTRU may send info on the amount of data payload or the buffer level (e.g., with respect to one or more configured threshold values) at the application, including data (e.g., SNs) waiting to be delivered to lower layers for UL transmission and/or data received in DL which may be waiting to be delivered to higher layers/application. In one example, the buffer info may be reported in terms of estimated or measured time duration for the data waiting in the buffer before delivered to lower layers or consumed by application. In another example, the buffer info may be reported in terms of data buffered at application/higher layer, new layer, SDAP, PDCP, RLC, MAC, LCG, LCHs. In another example, the buffer info may be reported in terms of payload size (e.g., total, instantaneous, mean, maximum, minimum) at the granularity of one or more data units (e.g., PDUs, PDU set, data burst. In another example, the buffer info may be reported in terms of SN range (e.g., SNs associated with first PDU/PDU set and/or last PDU/PDU set).

For example, the WTRU may send the QoS requirements or expected QoS of the one or more flows or data units (e.g., PDUs, PDU sets, data bursts), including data rate, latency, reliability, absolute/relative priority values, and the like. The information on QoS requirements may also include statistical/distribution info such as mean, minimum, maximum, standard deviation values. For another example, the WTRU may also indicate that such QoS requirements or expected QoS may be supported on different QoS granularities. The different QoS granularities may include per-PDU, per-PDU subgroup (e.g., one or more PDUs) within PDU set, per PDU set, per-group of PDU sets, per flow, or per session. The WTRU may also indicate a time window (e.g., start time, duration, end time) during which such QoS requirements or expected QoS may be applicable to the different QoS granularities.

For example, info on interfaces may include the number and/or types of interfaces (e.g., new radio (NR) Uu, NR SL, wireless local area network (WiLAN), Bluetooth), supported by the WTRU. For another example, the capability information on interfaces, possibly supported by WTRU and/or required by WTRU for supporting any of the WTRU actions and/or behaviors, may include one or more of the bandwidths, BWP, number of carriers, number of transmit antennas, number of receive antennas, and the like.

For example, the capability information related to WTRU actions, including visual sensing, possibly supported by WTRU (e.g., sensors, camera associated with WTRU) and/or required by WTRU may include any of the following: FoV resolution (e.g., megapixel count), rendered viewports (e.g., viewport ID), FoV size (e.g., 120 degrees), aperture size, startup time, image quality (e.g., minimal/maximal range), battery life, sound/audio, and display calibration (e.g., corrections applied for distortion and chromatic aberration).

For example, the WTRU may send to network one or more preferred mapping configurations forwarding configurations, and/or resource configurations (e.g., CG, DG) including specific parameters associated with the forwarding/resource configurations. The preference information may be for supporting in-sequence delivery of the data units and/or for supporting any of the associated WTRU actions. In an example, the WTRU may associate and/or indicate weight and/or probability values to different forwarding/resource configurations when sending request related to preferred configuration. For example, the weight and/or probability value may be determined based on the likelihood of a configuration to be applied during transmission and other application/AS-layer information/indication. The network may use such weight/probability info for determining and providing to WTRU a combined configuration and/or for activating/deactivating a configuration. The configuration may match with the weight values indicated by WTRU, for example.

For example, the info on updated forwarding configurations associated with the supported and/or requested user plane/control plane (UP/CP) configurations (e.g., radio bearers, LCHs, LCGs, links) may include absolute/relative importance/priority values associated with the UP/CP configurations (e.g., radio bearers, logical channels, links), or LCP configuration. In one example, the WTRU may indicate the updated LCP rules/restrictions (e.g., restrictions associated with mapping from DRB/LCHs to configured resource grants) that may be applied for a set of forwarding/resource configurations (e.g., CG), whether such LCP rules/restrictions may be temporarily changed for a time duration, conditional LCP configurations applicable when detecting certain configured events (e.g., surge in number of PDUs/data with high QoS requirements), or fallback/default LCP configurations.

For example, the WTRU may send an indication to network to request for activating/deactivating a mapping/forwarding/resource configuration and/or parameters associated with the configurations, possibly preconfigured in the WTRU. The WTRU may include the ID of the configuration/parameter when sending the request indication. In an example, the request to activate/deactivate a configuration may be accompanied with info on the WTRU action, e.g., splitting/merging QoS flows/PDU sets/data bursts/PDUs.

For example, the WTRU may send reference signal received power (RSRP), reference signal received quality (RSRQ), received signal strength indicator (RSSI) measurements of the signals, channels, radio links, carriers, and the like, possibly associated with the one or more WTRU actions. For another example, the WTRU may send the QoS related measurements related to arrival time and number of PDUs/PDU sets/data bursts received possibly over a time duration, change in the QoS (e.g., increase/decrease in data rate, latency, reliability), time-to-live associated with the PDUs/PDU sets/data bursts, remaining time for delivering the PDUs/PDU sets/data bursts.

The embodiments described herein and in the following sections of this invention may use any of the one or more of the above information (e.g., assistance information, preferred configurations) sent by the WTRU to network.

The WTRU may receive configuration information associated with in-sequence delivery of data units from the network. The WTRU may receive configuration information for supporting any of the procedures, mechanisms, rules, actions, and the like, associated with in-sequence delivery during UL transmissions and/or DL receptions of any of data units PDUs, PDU sets and data bursts in one or more data/QoS flows.

The WTRU may receive configuration information from network periodically (e.g., with one or more configured periodicity values), aperiodically/dynamically (e.g., status indication/information or request/request messages) and/or on semi-persistent basis (e.g., sent with a periodicity value over a time window/duration).

The WTRU may receive the configuration information via one or more of message types. The message types may include RRC signaling and/or messages (e.g., dedicated/unicast signaling via any of SRBs, broadcast/system information block (SIB)), control PDUs associated with any of the AS layers (e.g., SDAP control PDU, PDCP control PDU), DL MAC CE, DCI, PDCCH, PUSCH, non-AS (NAS) layer signaling (e.g., a PDU Session Establishment Response or a PDU Session Modification Command), or application layer signaling/messages.

The configuration information which may be received by WTRU from the network may include mapping/forwarding/resource configurations and associated parameters, AS layer status information and/or indications, validity information, and/or threshold values.

For example, the WTRU may receive one or more configurations and/or sets of parameters to be applied at different layers of AS protocol stack (e.g., RRC, SDAP, PDCP, RLC, MAC, PHY or any new layer). The configurations parameters to be applied at different layers may include Service Data Adaption Protocol (SDAP)/PDCP, PDCP, Radio Link Control (RLC), Medium Access Control (MAC), or Physical Layer (PHY).

SDAP/PDCP may include 1-to-1, 1-to-M or N-to-M mapping configurations, markings/indications/IDs to apply (e.g., associated with handling QoS flows, PDU sets, data busts, association info between PDU sets and data bursts), range of values associated with importance/priority info to identify in the PDUs/PDU sets. A SDAP mapping configuration may refer to information and/or criteria that is used to map the data units (e.g., PDUs, PDU sets, data bursts) at the SDAP layer to one or more PDCP entities/sublayers or DRBs. A PDCP mapping configuration may refer to information and/or criteria that is used to map the data units at the PDCP layer to one or more RLC entities/sublayers or LCHs. PDCP may include IDs and SNs to apply (e.g., range of COUNT/HFN/SN values to be apply for a one or more PDUs/PDU sets), indication of whether a per-PDU set level SN (e.g., new HFN) is to be applied, indication of whether a new set of SNs (e.g., new starting SN, new SN range, predefined SN gap) is to be applied on a per-PDU set basis, ROHC configuration, security/encryption parameters, packet duplication configuration (e.g., whether packet duplication is activated/deactivated). RLC may include whether AM/UM/transparent mode (TM) is to be applied and parameters associated with AM/UM/TM operation when supporting in-sequence delivery of PDUs/PDU sets. MAC may include LCH parameters (e.g., priority, PBR, BSD for PDU and/or PDU set level), LCP configurations (e.g., rules/restrictions/policy for PDU and/or PDU set level handling, time duration for changing between different LCP rules/policy), configurations for multiplexing/assembly/reordering. PHY may include MCS, PUSCH configurations (e.g., number of PUSCH occasions per slot), HARQ configurations.

For example, the WTRU may receive one or more resource configurations. In one example, the resource configurations may include configured grant resources/configurations for UL data transmissions. The parameters associated with CG resources/configurations may include any of periodicity, start offset, duration, BWPs, numerology/subcarrier spacing (SCS) values, number of PRBs, number of occasions, number of PUSCH slots per occasion, maximum number/duration/length of PUSCH, one or more MCS values for the grant, antenna ports, and the like, for example. In another example, the resource configurations may include semi-persistent scheduling (SPS) resources/configurations for DL data receptions. The parameters associated with SPS resources/configurations may include any of periodicity, start offset, duration, BWPs, numerology/SCS values, number of physical resource blocks (PRBs), number of occasions, number of physical downlink shared channel (PDSCH) slots per occasion, maximum number/duration/length of PDSCH, one or more MCS values for the grant, antenna ports, and the like, for example. In another example, the resource configurations may include dynamic grant resources for UL data transmission (e.g., triggered by UCI, SR, BSR, MAC CE). In another example, the resource configurations may include dynamic scheduling resources for DL data receptions (e.g., triggered by DCI, PDCCH, MAC CE).

The WTRU may receive at least one set of configuration parameters associated with default forwarding configuration (e.g., default set of LCHs). The default forwarding configuration may be activated and/or used during normal scenarios for transmitting/receiving data, for example. The WTRU may also receive another set of configuration parameters which may be associated with exceptional operation, possibly activated and/or used when detecting any of the triggering events/conditions (described herein), for example.

The WTRU may receive default priority values associated with the resource configurations (e.g., CG). For example, a first resource configuration may be associated with a first priority value. A second resource configuration may correspond to a second priority value. The first and second resource configurations may be associated with the same application and a first set of priority values may be intended to achieve a default QoS performance (e.g., default latency, default data rate) and a second set of priority values may be intended to achieve exceptional QoS performance (e.g., surge/burst data rate, very low latency) for the PDUs/PDU sets using the first and second resource configurations during transmission, for example.

The AS layer status information and/or indications may include the identifiers and/or IDs, a status of forwarding and/or resource configuration, a status of in-sequence delivery of PDUs and/or PDU set, and/or a flow control.

For example, the WTRU may receive info on one or more IDs to apply during transmission/reception. The info may include WTRU IDs, e.g., C-radio network identifier (RNTI), I-RNTI, NAS IDs, temporary mobile subscriber identity (TMSI)/international mobile subscriber identity (IMSI). The info may include IDs associated with application (e.g., application ID, service ID, session ID, application configuration ID). The info may include group ID (e.g., associated with group of QoS flows, group of forwarding configurations, group of devices/WTRUs). The info may also include IDs of individual QoS flows, mapping configurations, forwarding configurations. The info may also include data type/message ID (e.g., PDU set ID, data burst ID, flow ID, PDU ID). The info may also include resource config ID (e.g., CG IDs, SPS IDs).

For example, the WTRU may receive the information on QoS achieved/achievable (e.g., latency) when using one or more forwarding/resource configs. For example, The WTRU may receive the information in terms of the data-rate, latency (e.g., expected, remaining latency), reliability, priority achievable/achieved when transmitting/receiving any of the data units including PDUs, PDU sets and data bursts. The WTRU may also receive statistical/relative/absolute information associated with the QoS achieved/achievable, in terms of mean, maximum, minimum, standard deviation, and the like, for example.

For example, the WTRU may receive status report/feedback on the SN gaps including SNs of PDUs that are not received at the network, number of SN gaps and size of the SN gaps. The status report may be received by WTRU on the basis of per-PDU set, per-data burst or per group of data units (e.g., within a time window). For example, the status report received by the WTRU may indicate ACK/NACK on the SNs of a PDU set that are received or not received successfully. The WTRU may receive a status report associated with in-sequence delivery of a PDU set in the form of a bitmap, where each bit in the bitmap may indicate ACK/NACK corresponding to the SNs of PDUs within the PDU set that are received/not received, for example.

For example, the WTRU may receive from network explicit or implicit flow control indications indicating whether to start/increase/decrease/suspend/stop transmission of PDUs/PDU sets, possibly in terms of achieving an indicated rate of transmission, latency, reliability, in one or more forwarding configurations.

For example, the WTRU may receive validity information associated with the forwarding/resource configurations, indicating whether/when the configurations may be considered to be valid or invalid, based on one or more of triggering events/conditions. The WTRU may also receive information on whether the configurations are to be deactivated and/or released when determining them to be invalid.

For example, the WTRU may receive info on whether the configurations are to be considered as valid/invalid based on the RRC state of the WTRU (e.g., CONNECTED, INACTIVE, IDLE) and/or when transitioning between different RRC states.

For example, the WTRU may receive indication on whether to release any of the forwarding configurations.

The threshold values may include a buffer occupancy threshold, one or more PDU/PDU set payload size threshold values, one or more delay threshold values, one or more delay difference threshold values, and/or a correlation time window.

For example, the buffer occupancy threshold values associated with any of forwarding configurations may indicate the maximum/minimum amount of data units in one or more granularities/types including PDUs, PDU sets and data bursts (e.g., in terms of total payload size/volume) that are in one or more buffers (e.g., SDAP buffer, PDCP buffer, LCH buffer).

For example, the payload size threshold values may be associated with one or more upper and/or lower bound values corresponding to the total size of payload (e.g., in the units of bits or bytes) of one or more PDUs, PDU sets and/or data bursts. In another example, the payload size threshold values may be associated with one or more upper and/or lower bound values corresponding to the total number of PDUs in a PDU set, or total number of PDU sets in a data burst.

Delay threshold values may be associated with one or more upper and/or lower bound values corresponding to maximum/minimum delay value and/or remaining delay values (e.g., with respect to PSDB) associated with reception, buffering and/or transmission of any of data units (e.g., PDUs, PDU sets, data bursts). The delay threshold values may be intended to identify and/or determine the maximum/minimum latency tolerated by the network, application and/or WTRU, possibly as a result of delays due to processing, jitter, transmission, congestion, and the like, for example.

For example, delay difference threshold values may be associated with one or more upper and/or lower bound values corresponding to the difference between a first delay value (e.g., default delay) and a second delay value (e.g., new/updated delay value).

For example, the correlation time window may correspond to the minimum time difference between two triggering events (e.g., buffer level measurements, PDU/PDU set arrival time), where the two events may be considered as correlated between one and another when they occur within the correlation time window. When the two events occur at time instances beyond the correlation time window, they may be considered as independent. In an example, the WTRU may use the correlation time window for determining whether to send an indication to network (e.g., sending a status report on in-sequence reception of data units).

The embodiments described herein and in the following sections of this invention may use any of the one or more of the above configuration information received by the WTRU from the network.

Triggering events and/or conditions for ensuring in-sequence data delivery may be discussed as follows. The WTRU may be configured with one or more events/conditions related to triggering one of the WTRU actions described above, including sending assistance information/indications/reports to network, receiving configuration information/indications from network, sending indication/request for changing forwarding/resource configurations, and the like.

The triggering events/conditions may be associated with ensuring in-sequence delivery of data units and/or for meeting expected QoS when transmitting/receiving XR data units (e.g., PDUs, PDU sets, data bursts) in one or more QoS flows. Such triggering events/conditions may dictate whether and which an action may be performed by WTRU. For example, such triggering events/conditions may dictate when (at what time instance/slot) an action may be performed by WTRU (e.g., when any of events/condition/criteria described below is satisfied). For example, the WTRU may determine/select one or more forwarding configurations (e.g., DRBs, LCHs) for ensuring in-sequence delivery based on detection of one or more triggering events/conditions. The conditions/events may include an indication and/or information from the network, an indication and/or information from application and/or higher layers, a buffer status and loading at forwarding configurations (e.g., DRBs/LCHs), a change of configurations at WTRU, timing and/or timestamp information, possibly associated with expected QoS; one or more measurements on Uu links, a compensation based on status of in-sequence delivery and/or expected QoS, a property associated with the link/channel to which a forwarding configuration is associated, and/or detection of QoS events (surge in payload size, high importance data).

For example, the WTRU may receive from the network (e.g., gNB) an indication/information on whether in-sequence delivery is achievable, size and number of SN gaps, indication of out-of-sequence reception, and expected QoS for transmission and/or reception of any XR data units over the Uu link (in UL and/or DL). The information may be received semi-statically, during/upon configuration or dynamically. The WTRU may trigger an action (e.g., determining/selecting a mapping, forwarding or resource configuration), described in the solutions families herein, based on the indication/information received from network, for example. The indication/info on in-sequence delivery may be indicated on the basis of per PDU, per-PDU set, per data burst, per-QoS/data flow, per forwarding configuration, per-resource configuration, for example. In another example, the WTRU may receive from gNB the information on in-sequence delivery and/or expected QoS implicitly based on one or more of the following: number of time HARQ feedback is received, size and/or timing for allocation of resource grants (configured grant, dynamic grants), allocation of retransmission grant corresponding to one or more forwarding configurations (e.g., LCHs/DRBs/BWPs), de-prioritization of PUSCH/grant for one or more LCHs due to intra/inter WTRU prioritization, etc. For example, the WTRU may be triggered to perform any of the WTRU action(s) when receiving an indication from the network (e.g., in RRC, MAC CE, other control PDU or DCI). The indication received by the WTRU may be possibly related to the change/update in forwarding/resource configuration at WTRU, for example.

For example, the WTRU may perform any of the WTRU actions when receiving an indication from application/higher layers. The indication may include information on the change of traffic characteristics/patterns associated with the generation/processing/reception of XR data units in one or more flows. In an example, the application may indicate to WTRU the information on the expected number of QoS flows which may be associated with the application, expected number of PDUs per PDU set, whether any of PDU sets are dependent, expected frame/PDU set in a subsequent time instances (e.g., next frame generation instance), expected change in the distribution of importance/priority of PDUs generated, expected increase/decrease in latency (e.g., due to processing at codec/application), and/or jitter for delivering the data units in UL and/or DL, expected change in the time-to-live associated with the data units, expected change in WTRU/user motion/movement (e.g., increase/decrease in rate of motion), and the like, For another example, the WTRU may receive an indication from application/higher layers indicating the arrival of one or more data units (e.g., in a batch/burst) from application in the WTRU (for UL) or from application in network (in DL). The information on the arrival of the PDUs may include the expected timing (e.g., time slot/frame) of data unit generation at application, and expected timing of reception at WTRU, for example. The information may be indicated to WTRU via timestamps, and/or sequence numbers for example. For another example, the WTRU may be triggered to perform any of WTRU action(s) based on an indication of importance/priority for the transmitting data units. The WTRU may trigger an action (e.g., change forwarding/resource configuration) for retransmitting a lost/missing PDU and/or transmitting a delayed PDUs with compensation (e.g., low latency) when receiving an indication including an importance/priority value higher than a threshold, for example.

The buffer status may include at least a condition associated with one or more of measurements (e.g., compared to a threshold). The measurements may include the amount of XR data units in one or more buffers associated with forwarding configurations, possibly over a period of time, the rate of arrival/departure of data units in one or more buffers associated with forwarding configurations, the average, maximum, minimum size/volume of the data units in an buffer associated with forwarding configurations (e.g., number of PDUs in LCH buffer), a measure of the amount of time spent by one or more data units in buffers associated with forwarding configurations, and/or the number of forwarding configurations meeting a condition/threshold associated with the amount of data, arrival rate, data units (e.g., total payload size), and/or the like.

For example, a WTRU may perform any of the actions described in the solutions families herein (e.g., change the forwarding configuration and/or change resource configuration) if at least one data units in a forwarding configuration (e.g., UL LCH buffer waiting to be transmitted in UL and/or DL LCH/higher layer buffer waiting to be processed) is in the buffer for a period of time larger than a threshold time value.

For example, a WTRU may perform any of the actions described in the solution families herein (e.g., send a report or status indication) if the buffer status of forwarding configuration exceeds a threshold.

For example, other buffer status metrics may be monitored for determining the expected QoS include the number of data units buffered which are above/below a configured threshold in one or more associated forwarding configurations, and/or the rate of data units arrival/departure in the buffer with respect to a configured arrival/departure rate, for example.

For example, the WTRU may be triggered to perform a WTRU action(s) (e.g., sending an indication/report to network) when determining a change to a mapping configuration, forwarding configuration and/or resource configuration, including changing at least one of the parameters at the mapping configuration (e.g., mapping a QoS flow to a new forwarding configuration), DRB/LCHs (e.g., priority, PDB, PBR, PSDB, PSER), LCP configuration and/or resource configuration/parameters (e.g., CG, DG, SPS).

For example, the WTRU may be triggered to perform a WTRU action(s) when the connected mode discontinuous reception (CDRX)/discontinuous reception (DRX) configuration and any of the associated parameters applied at the WTRU is modified/updated, which may possibly impact the transmission/reception pattern and/or QoS achievable during data transmission.

For example, the WTRU may track the timing related information (e.g., timestamp, sequence number, marker or timing control PDU) in the one or more data units received in an earlier time window for determining the latency or jitter. The timing information may then be used for determining whether/how to achieve in-sequence delivery and whether QoS may be met for upcoming/new data units in the next time window, for example.

In an example, the timing information may be determined/indicated as a deadline/latency bound and/or survival time that may be satisfied on a per-PDU, per-PDU set, per-data burst or per-QoS flow basis. The timing information may be determined across one or more associated/correlated QoS flows, including the correlated UL flows, and correlated DL flows, for example. In another example, the timing information may also be determined/indicated on a count basis (e.g., data unit count). The WTRU may trigger an action (e.g., determining mapping/forwarding configuration), described in the solutions families herein, when determining the timing information and its impact on in-sequence delivery, for example.

In another example, the WTRU may send information/indications/reports to network (described in another section of the invention) periodically or based on a setting/expiry of a configured timer.

The WTRU may perform measurements over the Uu link, for example, corresponding to RSRP, RSSI, channel quality indicator (CQI) and CSI, for determining the expected QoS. The channel/load measurements made over a certain configured time duration may indicate whether the data units may be able to achieve the expected QoS during transmission and/or reception, or may exceed the QoS budget (e.g., PSDB). The WTRU may trigger an action (e.g., determining mapping configuration), described in the solutions families herein, based on the measurements on Uu link, for example.

In an example, the WTRU may determine the Uu link conditions based on the number of ARQ/HARQ (ACK/NACK) feedback messages and/or automatic repeat request (ARQ)/HARQ retransmissions made over the one or more HARQ processes associated with the forwarding configurations applied for sending the data units. The in-sequence delivery status (e.g., size of SN gap, delays for reordering) may be determined based on a (configured) mapping between the feedback/retransmission (ReTx) count in UL and/or DL and reordering delay, for example. As an example, a ReTx count above a threshold may translate to poor Uu link/channel conditions, and hence, reduced time duration for reordering.

For example, the WTRU may be triggered to perform WTRU action(s) and/or send an indication to network when channel measurements made (e.g., RSRP, RSSI, RSRQ, CQI, CSI) on Uu link increases/decreases with respect to a configured threshold and/or remains above/below a threshold for a certain time duration.

For example, the WTRU may be triggered to perform WTRU action(s) when one or more QoS related measurements (e.g., latency measured for data units in one or more forwarding configurations) exceeds a certain threshold.

In another example, the WTRU may trigger an action, described in the solutions families herein, based on determination of the time duration/jitter or change in the time duration/jitter between reception of consecutive PDUs associated with an PDU set or consecutive PDU sets associated with a data burst, and/or reception of data units in one or more correlated flows in UL and/or DL. For example, the WTRU may infer an increase/decrease in the jitter between consecutive PDUs for determining whether the processing load at application/higher layer is high/low. In this case, for determining the time duration, the WTRU may set a timer when a first data unit arrives and reset the timer when an associated second data unit arrives, for example.

For example, the WTRU may be triggered to perform WTRU action(s) based on determination in-sequence delivery status (e.g., size of SN gap) and/or expected QoS for one or more data units, including indication on whether the data units may be either delayed or arrive early, during UL transmission and/or DL reception. In this case, the WTRU may trigger an action such that the delayed or early data units may be transmitted with a determined compensation amount, for example, by selecting suitable forwarding configurations. In an example, the action(s) may be triggered when detecting a change (e.g., higher/lower) in the expected QoS for the data units by a certain threshold.

In an example, the WTRU may determine the delayed PDU to be sent using a forwarding configuration that enables satisfying a compensation amount, where the compensation amount may be determined by subtracting the expected latency from actual latency, for example.

For example, the WTRU may be configured with a property specific to the forwarding configuration/link/channel. The forwarding configuration/link/channel may include a forwarding configuration/link/channel priority, or a configuration parameter enabling/disabling the specific action for the forwarding configuration/link/channel. For example, the forwarding configuration/link/channel configured with high priority may allow the WTRU to change any configuration (with respect to an initial or default configuration). For example, the WTRU may change the parameters of a forwarding configuration associated with high priority as long as the change impacts other lower priority forwarding configurations (e.g., only other lower priority forwarding configurations).

For example, QoS events may include surge events associated with an increase in the number of data units or data volume, possibly over a time window, indicated/marked with high importance/priority. Likewise, other QoS event may include QoS deflation associated with a decrease in the number of data units or data/payload volume over a time window, for example.

For example, the WTRU may be triggered to perform WTRU action(s) when detecting one or more QoS events, possibly by considering the indicated/determined the duration the QoS events are expected to persist. The WTRU may then perform other WTRU actions that may result in falling back to the default configurations, possibly after the end of the detected QoS events, for example. In an example, when a surge event (e.g., increase in total payload or number of PDU sets) is detected, the WTRU may trigger an action to change the resource configuration in UL and/or DL (e.g., CG and/or SPS updated for the duration of the surge). When determining reduction in the surge or end of surge event, the WTRU may be fallback to using the default resource configuration in UL and/or DL (e.g., default CG and/or SPS).

The WTRU may determine the dependency and/or association info between XR data units for in-sequence unit. The WTRU may determine whether the PDUs in one or more flows transmitted in UL and/or received in DL are inter-dependent and/or associated with a data unit (e.g., PDU set, data burst). The WTRU may determine the association of the PDUs to PDU set and/or data burst based on explicit indication and/or implicit parameters/identifiers detectable by WTRU in the PDUs or flows. Upon determining the association/dependency of the PDUs with a PDU set and/or association of PDUs/PDU sets with a data burst, the WTRU may perform certain actions that may result in in-sequence delivery during transmission.

The parameters/identifiers for determining the association of PDUs with data units may be configured in the WTRU (e.g., via RRC signaling, NAS-layer signaling and/or application/higher layer signaling), for example. The WTRU may assign the SNs to the PDUs/PDU sets during UL transmission of the data units based on the determination of the dependency/association information between the different data units. For example, when identifying that a first data unit and a second data unit may be inter-dependent, the WTRU may assign a new start SN value (e.g., by resetting and starting COUNT, HFN, SN) and/or with a new range of the SNs values for the first and second data units.

The parameters/identifiers used by WTRU for identifying the association of PDUs with the data units may include one or more identifiers, IDs, indexes, or sequence numbers, a priority or importance information associated with flows, temporal or timing information in associated flow, and/or explicit information from application, higher layers, or AS-layers.

For example, the WTRU may determine a first PDU and/or a second PDU in a same QoS flow or different QoS flows may be associated with a PDU set, when detecting a common IDs/indexes/SNs associated with the PDU set. The ID may be detected within the PDUs (e.g., in header and/or payload) in one or more QoS flows. The ID of the PDU set and/or application associated with the PDU set may be preconfigured in the WTRU, for example. Similar set of IDs/indexes/SNs may be used for identifying the association of one or more PDU sets with a data burst, for example.

For example, the WTRU may determine a first PDU and/or a second PDU in one or more QoS flows may be associated with a PDU set, based on detection of common and/or similar importance/priority indications in the PDUs (e.g., in header and/or payload) in the QoS flows. The importance/priority indications may be related to spatial or temporal indications, for example. In another example, the WTRU may determine the PDUs which may be associated with a PDU set when the importance/priority indications detected by WTRU (e.g., in PDU header or payload) may be above/below one or more importance/priority threshold values. Similar importance/priority indications may be used for identifying the association between PDUs/PDU sets with a data burst, for example.

For example, the WTRU may determine a first PDU and/or a second PDU in one or more QoS flows may be associated with a PDU set when the PDUs are received or arrive at the WTRU within a time duration/window. The time duration/window may correspond to the time difference between the reception time of a first PDU (e.g., at t1) and a second PDU (e.g., at t2) within the same QoS flow, for example. Likewise, the time duration/window may correspond to the time difference between the reception time of a PDU in first QoS flow (e.g., at t1) and the reception time of a PDU in second flow (e.g., at t2), for example. In this case, the WTRU may determine that the first and second PDUs in the same or different QoS flows may be associated with a PDU set when the time difference (e.g., t2−t1) is less than a time duration/window threshold value. In an example, the time duration/window threshold value may be associated with the frame-rate used by the application/higher layer (e.g., 60 Hz, 120 Hz) for generating the PDUs/PDU sets. Similar approach may be applied for determining the association between PDUs/PDU sets with a data burst based on the temporal/timing information, for example. In another example, the WTRU may determine the first and second PDUs in one or more flows may be associated with an PDU set, or may be associated with a data burst, based on a common format and/or granularity of the timing information (e.g., timestamps, packet count, sequence numbers) carried in the PDUs (e.g., headers, payload).

For example, the WTRU may determine a first PDU and/or a second PDU in one or more QoS flows may be associated with a PDU set or a data burst, when receiving an explicit indication/message from higher-layers/AS-layers in WTRU or network. In an example, the WTRU may receive in the indication, the timing information (e.g., periodicity, burst time window/duration) during which the PDUs may be associated. In this case, outside of the timing information (e.g., burst duration), the WTRU may assume that the PDUs may be uncorrelated and/or not associated with a PDU set or a data burst, for example.

The WTRU may select forwarding configurations at AS layers for in-sequence data delivery. The WTRU may receive one or more data units (e.g., PDUs, PDU sets, data bursts) from higher layers/application and may map the data units to selected one or more forwarding configurations (e.g., DRBs, and/or LCHs) for in-sequence delivery when performing UL transmission and/or DL reception.

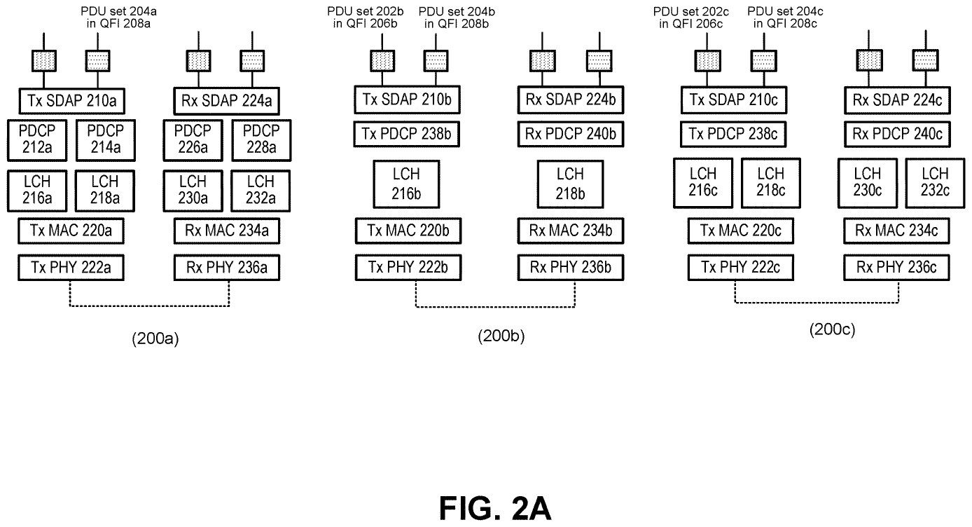

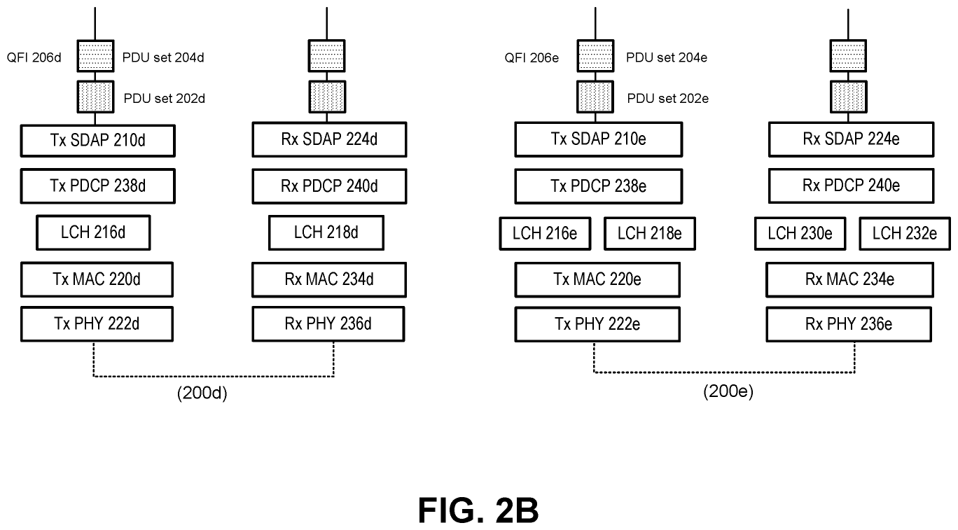

FIGS. 2A and 2B illustrate example forwarding configurations at AS layers for in-sequence data delivery. As shown, the WTRU may map one or more data units to select one or more forwarding configurations 200a-200e (e.g., DRBs, and/or LCHs) for in-sequence delivery when performing UL transmission and/or DL reception using (a) configuration 200a (e.g., PDU sets in multiple QFIs are mapped to multiple DRBs), (b) configuration 200b (e.g., PDU sets in multiple QFIs are mapped to a single DRB), (c) configuration 200c (e.g., PDU sets in multiple QFIs are mapped to a single DRB and multiple LCHs), (d) configuration 200d (e.g., PDU sets in a single QFI are mapped to a single DRB), and (e) configuration 200e (e.g., PDU sets in a single QFI is mapped to a single DRB and multiple LCHs).

In one example related to configuration 200a illustrated in FIG. 2A, the WTRU may receive one or more PDUs associated with PDU set 202a and PDU set 204a in QFI 206a and QFI 208a, respectively. The received PDU sets may be mapped to DRB1 (e.g., PDCP 212a) and DRB2 (e.g., PDCP 214a) at the SDAP sublayer/entity 210a/240a. For supporting in-order delivery of the PDU sets, the SNs (e.g., COUNT) or other indications/markers (described in other sections of the invention) may be added to PDU set 202a and PDU set 204a at any of SDAP sublayer/entity, a new sublayer/entity below SDAP or at a new sublayer/subfunction/entity above PDCP 212a and PDCP 214a (e.g., higher/common PDCP sublayer), for example. The SNs may be assigned on a per-PDU basis (e.g., for each PDU within a PDU set) and/or on a per-PDU set basis (e.g., for each PDU set). Each PDCP entity (e.g., PDCP 212a and PCDP 214a) may be configured to support in-sequence delivery of PDUs in PDU set 202a and PDU set 204a, respectively. For example, each PCDP entity may add SNs to the PDUs associated with the PDU set 202a and PDU set 204a, respectively. The PDUs of PDU set 202a and PDU set 204a may be mapped to LCH 216a and LCH 218a, possibly corresponding to RLC1 and RLC2 respectively. The MAC entity/sublayer 220a/234a may ensure the QoS of the PDU sets (e.g., PSDB) in the respective LCHs may be met, possibly based on the PDU set parameters (e.g., priority, remaining delay), LCH parameters (e.g., priority, PBR, BSD) and/or using LCP procedure, during scheduling and/or multiplexing of the PDU sets into one or more TBs and UL transmission, for example. The Tx PHY entity/sublayer 222a may perform PHY layer processing (e.g., encoding, modulation, resource mapping, antenna mapping) of the data prior to transmission. The transmitted data may be received at the Rx PHY entity/sublayer 236a for PHY layer processing (e.g., demodulation, decoding). The data may be further processed at the receiving Rx MAC entity/sublayer 234a. The data may be mapped to LCH 230a and LCH 232a based on info in the PDU headers. The data in LCH 230a and LCH 323a may be further mapped to the Rx PDCP entities 226a and 228a, respectively. In an example associated with DL reception, the receiving PDCP entities (e.g., PDCP 226a and PDCP 228a at WTRU), may perform reordering of the PDUs corresponding to PDU set 202a and PDU set 204a respectively, based on the SNs or other indications (described other sections of the invention) with the PDUs within the PDU set by the transmitting entities, before delivering the PDU sets to higher layers. Alternatively, for example, the SDAP entity or an entity above the PDCP 226a and PDCP 228a may perform reordering of the PDUs within the PDU set 202a and PDU set 204a, respectively, based on the SNs. For example, The SDAP entity or an entity above the PDCP 226a and PDCP 228a may perform reordering of the PDU sets, based on the SNs or other indications associated with the different PDU sets by the transmitting entities.

In one example related to configuration 200b illustrated in FIG. 2B, the WTRU may receive one or more PDUs associated with PDU set 202b and PDU set 204b in QFI 206b and QFI 208b, respectively. The received PDU sets may be multiplexed/mapped to DRB1 (e.g., PDCP 238b) at the SDAP sublayer/entity 210b/224b. For supporting in-order delivery of the PDU sets, the SNs or other indications (described other sections of the invention) may be added to PDU set 202b and PDU set 204b (on per-PDU basis and/or on per-PDU set basis) at any of the SDAP sublayer/entity, a new sublayer/entity below SDAP 210b or at PDCP 238b, for example. The PDUs of PDU set 202b and PDU set 204b may be mapped to LCH 216b, possibly corresponding to RLC1. The MAC entity/sublayer may ensure the QoS of the PDU sets (e.g., PSDB) in LCH 216b may be met, possibly based on the PDU set parameters (e.g., priority, remaining delay, SNs) and/or using LCP procedure, during scheduling and/or multiplexing of the PDU sets into one or more TBs and UL transmission, for example. The Tx PHY entity/sublayer 222b may perform PHY layer processing (e.g., encoding, modulation, resource mapping, antenna mapping) of the data prior to transmission. The transmitted data may be received at the Rx PHY entity/sublayer 236b for PHY layer processing (e.g., demodulation, decoding). The data may be further processed at the receiving Rx MAC entity/sublayer 234b. The data may be mapped to LCH 218b based on info in the PDU headers. The data in LCH 218b may be further mapped to the Rx PDCP entity 240b. In another example associated with DL reception, the receiving PDCP entity (e.g., PDCP 240b at WTRU), may perform reordering of the PDUs corresponding to PDU set 202b and PDU set 204b respectively, based on the SNs or other indications (described other sections of the invention) associated with the PDUs within the PDU set and across different PDU sets by the transmitting entities, before delivering the PDU sets to higher layers. Alternatively, the SDAP entity 224b or an entity above the PDCP 240b may perform reordering of the PDUs within the PDU set 202b and PDU set 204b, respectively, and across different PDU sets, based on the SNs, for example.

In one example related to configuration 200c illustrated in FIG. 2A, the WTRU may receive one or more PDUs associated with PDU set 202c and PDU set 204c in QFI 206c and QFI 208c, respectively. The received PDU sets may be mapped to DRB1 (e.g., PDCP 238c) at the SDAP sublayer/entity. For supporting in-order delivery of the PDU sets, the SNs or other indications (described other sections of the invention) may be added to PDU set 202c and PDU set 204c, on a per-PDU basis and/or per PDU set basis, at any of the SDAP sublayer/entity, a new sublayer/entity below SDAP or at PDCP 238c, for example. The PDUs of PDU set 202c and PDU set 204c may be mapped to LCH 216c and LCH 218c, possibly corresponding to RLC1 and RLC2 respectively. For example, the MAC entity/sublayer 220c/234c may ensure the QoS of the PDU sets (e.g., PSDB) in the respective LCHs may be met, possibly based on the PDU set parameters (e.g., priority) and/or using LCP procedure, during scheduling and/or multiplexing of the PDU sets into one or more TBs and UL transmission. The Tx PHY entity/sublayer 222c may perform PHY layer processing (e.g., encoding, modulation, resource mapping, antenna mapping) of the data prior to transmission. The transmitted data may be received at the Rx PHY entity/sublayer 236c for PHY layer processing (e.g. demodulation, decoding). The data may be further processed at the receiving Rx MAC entity/sublayer 234c. The data may be mapped to LCH 230c and LCH 232c based on info in the PDU headers. The data in LCH 230c and LCH 232c may be further mapped to the Rx PDCP entity 240c. The data in Rx PDCP entity 240c may be mapped to the Rx SDAP entity 224c. In another example associated with DL reception, the receiving PDCP entity (e.g., PDCP 240c at WTRU), may perform reordering of the PDUs corresponding to PDU set 202c and PDU set 204c respectively, based on the SNs or other indications (described other sections of the invention) associated with the PDUs within the PDU set and across different PDU sets, before delivering the PDU sets to higher layers. Alternatively, for example, the SDAP entity 210c/224c may perform reordering across different PDU sets, based on the associated SNs.

In another example related to configuration 200d illustrated in FIG. 2B, the WTRU may receive one or more PDUs associated with PDU set 202d and PDU set 204d in QFI 206d. The received PDU sets may be mapped to DRB1 (e.g., PDCP 238d) at the SDAP sublayer and/or entity 210d. For supporting in-order delivery of the PDU sets, the SNs or other indications (described other sections of the invention) may be assigned to PDU set 202d and PDU set 204d, on a per-PDU basis and/or per-PDU set basis, at any of the SDAP sublayer and/or entity, a new sublayer and/or entity below SDAP 210d or at PDCP 238d, for example. The PDUs of PDU set 202d and PDU set 204d may be mapped to LCH 216d, possibly corresponding to RLC1. The MAC entity and/or sublayer 220d/234d may ensure the QoS of the PDU sets (e.g., PSDB) in LCH 216d may be met, possibly based on the PDU set parameters (e.g., priority) and/or using LCP procedure, during scheduling and/or multiplexing of the PDU sets into one or more TBs and UL transmission, for example. The Tx PHY entity/sublayer 222d may perform PHY layer processing (e.g., encoding, modulation, resource mapping, antenna mapping) of the data prior to transmission. The transmitted data may be received at the Rx PHY entity/sublayer 236d for PHY layer processing (e.g., demodulation, decoding). The data may be further processed at the receiving Rx MAC entity/sublayer 234d. The data may be mapped to LCH 218d based on info in the PDU headers. The data in LCH 218d may be further mapped to the Rx PDCP entity 240d. The data in Rx PDCP entity 240d may be mapped to the Rx SDAP entity 224d. In another example associated with DL reception, the receiving PDCP entity (e.g., PDCP 240d at WTRU), may perform reordering of the PDUs corresponding to PDU set 202d and PDU set 204d respectively, based on the SNs or other indications (described other sections of the invention) associated with the PDUs within the PDU set and across different PDU sets, before delivering the PDU sets to higher layers.

In another example related to configuration 200e illustrated in FIG. 2B, the WTRU may receive one or more PDUs associated with PDU set 202e and PDU set 204e in QFI 206e. The received PDU sets may be mapped to DRB1 (e.g., PDCP 238e) at the SDAP sublayer and/or entity 210e. For supporting in-order delivery of the PDU sets, the SNs or other indications (described other sections of the invention) may be added to PDU set 202e and PDU set 204e at any of the SDAP sublayer and/or entity, a new sublayer and/or entity below SDAP or at PDCP 238e, for example. The PDUs of PDU set 202e and PDU set 204e may be mapped to LCH 216e and LCH 218e, possibly corresponding to RLC1 and RLC2 respectively, by the PDCP 238e based on PDU set attributes (e.g., importance, payload size, number of PDUs, remaining delay, etc.). The MAC entity and/or sublayer 220e/234e may ensure the QoS of the PDU sets (e.g., PSDB) in the respective LCHs may be met, possibly based on the PDU set parameters/attributes (e.g., priority) and/or using LCP procedure, during scheduling and/or multiplexing of the PDU sets into one or more TBs and UL transmission, for example. The Tx PHY entity/sublayer 222e may perform PHY layer processing (e.g., encoding, modulation, resource mapping, antenna mapping) of the data prior to transmission. The transmitted data may be received at the Rx PHY entity/sublayer 236e for PHY layer processing (e.g., demodulation, decoding). The data may be further processed at the receiving Rx MAC entity/sublayer 234e. The data may be mapped to LCH 230e and LCH 232e based on info in the PDU headers. The data in LCH 230e and LCH 232e may be further mapped to the Rx PDCP entity 240e. The data in Rx PDCP entity 240e may be mapped to the Rx SDAP entity 224e. In another example associated with DL reception, the receiving PDCP entity (e.g., PDCP 240e at WTRU), may perform reordering of the PDUs corresponding to PDU set 202e and PDU set 204e respectively, based on the SNs or other indications (described other sections of the invention) associated with the PDUs within the PDU set and across different PDU sets, before delivering the PDU sets to higher layers.

The WTRU may support in-sequence delivery of XR data units during UL transmission and/or DL reception. The WTRU may be configured to perform in-sequence/in-order delivery of the data units associated with PDUs, PDU sets, data bursts or groups thereof when transmitting the data in UL to the network and/or receiving the data in DL. The procedures, criteria and/or conditions for performing in-sequence delivery of the data units may be configured in the WTRU by the network (e.g., via RRC signaling), for example. In one solution, the network may send to the WTRU indications on changes to the procedures, criteria and/or conditions to perform in-sequence delivery of data units.

In an example related to UL transmission, the WTRU may receive one or more data units, including PDUs, PDU sets, and/or data bursts or groups thereof, from higher layers. The WTRU may forward the data units to lower layers, upon processing, and transmit in UL such that the data is received at network in an order intended by application, higher layers and/or network, for example. In the case of DL, for example, the WTRU may receive the one or more data units from network. For example, the WTRU may ensure that the received data units are arranged or staggered in a particular order/sequence intended by the application, higher layers and/or network, prior to forwarding the data to the higher layers.

The operation/functionalities related to in-sequence delivery of the data units performed by the WTRU may include one or more of an allocation and/or an assignment of sequence numbers (SNs) or identifiers (IDs), retransmission of missing data units, and/or buffering for ensuring in-sequence delivery.

For example, the SNs or IDs may be allocated/included for different granularities of data units including on a per-PDU basis, per-PDU set basis, per-data burst basis or per group of any one or more of the aforementioned data units. In this case, for example, for each of the PDU sets received from higher layers, the WTRU may include a per-PDU set SN or ID. Such per-PDU set SN or ID may be common and/or included in one or more (e.g., all) PDUs associated with the PDU set, for example. The format in which the WTRU may assign the SN to the PDU sets may be sequential on a first-come-first-serve basis such that the PDU set arriving first in time may be assigned with SN x followed by the PDU set arriving next assigned with SN x+1, and the like. PDUs within the PDU set may also be assigned SNs, sequentially in their order of arrival within the PDU set. PDUs and/or PDU sets may be assigned numbers to associate the dependencies between them. For example, (x,1), (x,2), (x,3) may be assigned to PDUs 1, 2 and 3 of PDU set x by the WTRU.

In one solution, the WTRU may allocate the SNs to the data units in an incremental manner based on a criteria, including the order in which the data units are received from higher layers, markings (e.g., SNs, IDs, timestamps, priority/importance) indicated by higher layers/application in the data units (e.g., header of data unit) and time window in which the data units are received. For example, a first PDU set received from a higher layer may be allocated with a first SN and a second PDU set received following the first PDU set may be allocated with a second SN where the value of the second SN may be higher than the first SN.

In one solution, for the SNs allocated and added by the WTRU to the data units, there may be a start value and an end/upper bound value (e.g., super-frame number value). Beyond the end/upper bound value the WTRU may restart the allocation of the SNs to the new data units received, for example.

In an example, the upper bound value for the SNs may be associated with a validity time value, validity counter (e.g., HFN range), timer or delay bound value. In this case, the WTRU may continue to increment the SNs during allocation from an initial/start SN value until the SN reaches the end/upper bound so long as the validity time or counter value is valid. If the validity time or counter is determined to be not valid or an associated timer has expired prior to reaching the end/upper bound, the WTRU may reset the SNs allocation and use the start SN value when allocating the SNs to the new data units received.

In an example, for differentiating between different PDU sets, the SNs assigned to the last PDU of a first PDU set, and the first PDU of a second PDU set may differ by a fixed SN gap or an SN offset value. For example, when configured with an SN offset/gap value of 10, the last PDU of PDU set 1 may be assigned with SN value 500 and the first PDU of the following PDU set 2 may be assigned with SN value 510.

In the case of UL transmissions, for example, the WTRU may retransmit any of the data units (e.g., PDUs, PDU sets, data bursts or groups thereof) that may not be successfully received or received in-order by the network. The retransmission of the data units may be performed when the WTRU receives a status indication or a request indication from the network. For another example, the WTRU may retransmit one or more of the missing data units when receiving in the status/request indication, possibly indicating the SNs of the successfully received data or SNs of the data not received by network (e.g., SN gaps). In another example, the WTRU may also retransmit some of the data units. The data units may be dependent or associated with previously transmitted data or data requested by the network to be retransmitted. In another example, when retransmitting some of the missing data units, the WTRU may apply a different forwarding configuration (e.g., use more robust modulation and coding scheme (MCS), use different links, channels, beams, resources, resource sets) to ensure higher reliability during retransmission.

In the case of DL reception, for example, the WTRU may identify the SNs of the data units that may not have been received in sequence or missing at the WTRU. The WTRU may then generate and/or transmit an indication to the network (e.g., status indication, request message) indicating the SNs of the successfully received data or SNs of the data not received by the WTRU. The indication (e.g., status/request indication) may be transmitted by the WTRU periodically or when detecting one or more preconfigured events (e.g., expiry of a timer, number of missing data (e.g., SN gaps) are above a threshold value.

For example, the WTRU may buffer any of the data units transmitted or retransmitted in UL when receiving an indication (e.g., status indication, request message) from network. The WTRU may discard the buffered data units upon receiving an indication indicating successful in-sequence reception of data units. In another example, where the WTRU may receive any of the data units from application/higher layer, the WTRU may buffer the one or more data units that may be received out-of-order (e.g., data with later SNs/IDs/timestamps are received before data with earlier SNs/IDs/timestamps) until all data is received in-order, prior to sending the data units to lower layers. Similarly, in the case of DL reception, the WTRU may buffer any of the data units received out-of-order (e.g., data with later SNs are received before data with earlier SNs) until receiving all data in-order, before sending the data to application/higher layers. In another example, the WTRU may buffer the data received out-of-order in UL or DL for a certain configured time duration before forwarding the data or discarding the buffered data. For example, the time duration may be associated with the delay budget associated with the data units (e.g., PSDB). In one solution, the time duration may be configured depending on the data unit (e.g., size of data unit) that was received out-of-order. For example, if some PDUs within a PDU set or some PDUs within a data burst are received out of order, the time duration may be smaller compared to if some PDU sets are received out of order. In one solution, the time duration may be configured depending on the number of data units that were received out or order, for example, the more data units received out of order, the longer the time duration for the WTRU to buffer the out-of-order data before forwarding/discarding the buffered data.

The different entities/sublayers where the WTRU may have operations/functionalities associated with in-sequence delivery of the data units (e.g., PDUs, PDU sets, data bursts), as described above, may include at any one or more of a sublayer/subfunction within or at SDAP, PDCP, RLC, MAC (e.g., at one or more LCHs), PHY and/or a new sublayer.

In an example, where the WTRU may receive one or more data units (e.g., PDU sets) from higher layers in one or more data/QoS flows, the WTRU may be configured to map the received data units to multiple DRBs (e.g., PDCP entities/sublayers). In this case, the functionality for supporting in-sequence delivery (e.g., allocation of SNs, retransmission, reordering) may be performed at one or more of a SDAP sublayer and/or entity, a new layer between SDAP and the one or more PDCP entities and/or sublayer, and/or a subfunction and/or sublayer within PDCP. For example, the subfunction/sublayer within PDCP may be located at an upper level of PDCP, which may be common to one or more (e.g., all) lower level PDCP entities to which the PDU sets received from higher layers/SDAP may be mapped to.

In another example, the WTRU may be configured to map the data units (e.g., PDU sets) received in one or more data/QoS flows to a single DRBs (e.g., PDCP entity/sublayer). For example, the functionality for supporting in-sequence delivery may be performed at the SDAP sublayer/entity and/or at the PDCP sublayer and/or entity.

The WTRU may determine whether and/or how to suspend and/or resume the reordering of PDUs in different PDU sets based on detection of SN gaps.

In examples, the WTRU may determine whether and/or how to suspend and/or resume the reordering of PDUs associated with one or more PDU sets, which may be received in different PDU groups/bursts, based on detection of SN gaps in the different PDU groups. One or more of the actions described herein may be performed at the receiving entities at the WTRU, including at SDAP, PDCP, a new sublayer and/or MAC, for example, when the data units (e.g., PDUs, PDU sets, data bursts) are received in DL. One or more of the actions described herein may apply when the data units are lost during transmission or retransmission, or not received successfully at the receiving entities (e.g., PDUs of PDU sets are not received within the PSDB and/or PSER). One or more of the actions described herein may apply when PDU sets are differentiated implicitly based on an SN gap introduced by the transmitting entity during DL transmission (e.g., PDU set ID is not explicitly indicated by the transmitting PDCP entity at network).

In examples, the WTRU may receive configuration information from the network, including at least one or more threshold values associated with a reordering timer duration associated with the reordering of PDUs in one or more PDU sets. The WTRU may also receive, in the configuration information one or more new PDU set SN gap values, corresponding to the difference in the SN values between two consecutive PDU sets (e.g., difference in SNs between the last PDU of a first PDU set and the first PDU of a second PDU set)

The WTRU may receive, from network, a first PDU group including one or more PDUs of a PDU set. The WTRU may perform reordering of the PDUs, possibly in an ascending order at any of the receiving entities (e.g., PDCP, SDAP) based on the SNs (e.g., COUNT, HFN, SN) assigned by the transmitting entities at network. The WTRU may start one or more timers upon receiving the PDUs of the PDU set from network and/or from the lower layers (e.g., RLC/LCH). For example, the timers may be started when the first PDU of the first group of PDUs is received or when reordering of the PDU is started. The timers may be stopped and/or reset when the last PDU of the first group of PDU are received or upon completion of reordering, for example. While performing reordering of the PDUs in the first PDU group, the WTRU may receive a second PDU group including one or more PDUs of the PDU set. The WTRU may determine whether there are any missing PDUs in the first PDU group and second PDU group for in-sequence delivery (e.g., SN gaps) based on the reordering of the PDUs.

If any SN gap corresponding to the configured new PDU set SN gap value is detected between the any PDU in the first PDU group and any PDUs in the second PDU group (e.g., between last PDU of first PDU group and first PDU of the second PDU group), the WTRU may suspend the ordering of the PDUs in the first PDU group and/or may buffer the PDUs in the first PDU group. For example, the PDUs in the first PDU group and second PDU group may belong to different PDU sets and as such, the WTRU may not be able to find any PDUs missing from the first PDU group in the second PDU group, for example. Upon suspending the reordering, the WTRU may start a reordering timer, during which the WTRU may expect reception of a third PDU group. If a third PDU group of one or more PDUs are received from network, and if any missing PDUs in the first PDU group are not detected in the third PDU group within the reordering timer, the WTRU may reorder the PDUs in the second PDU group and third PDU group in ascending order and deliver the PDUs to upper layers, possibly when an end marker (e.g., last SN of a PDU set or flag) is identified in the ordered PDUs. If a third PDU group is received from network and if any missing PDUs in the first PDU group are detected in the third PDU group within the reordering timer, the WTRU may resume the ordering of the PDUs based on the PDUs received in the first PDU group and third PDU group in ascending order. The WTRU may deliver the PDUs to upper layers, possibly when an end marker is identified in the ordered PDUs.

The WTRU may transmit a status indication and/or feedback to network, indicating the action associated with in-sequence delivery and/or the information on the received/missing PDUs (e.g., SN gaps, ACK/NACK status of the SNs), during any of the steps associated with in-sequence delivery, including reception of PDUs in one or more PDU groups, detection of any SN gaps in the PDU groups, suspension/resumption of reordering of PDUs, delivery of the PDUs or upper layers.

In examples, the WTRU may perform one or more of actions related to In-sequence reception of multiple PDU sets in DL. The actions may include the WTRU receiving configuration information. The configuration information may include a PDU set reordering time duration. The actions may include the WTRU receiving, from NW, a first group of one or more PDUs of a PDU set. The actions may include the WTRU determining the order of the PDUs based on SNs of the PDUs in the first group. The actions may include the WTRU receiving, from NW, a second group of one or more PDUs of a PDU set. If an SN gap is detected between the last PDU of first group and first PDU of the second group, the WTRU may suspend ordering of the PDUs in the first group and buffers the PDUs, start the reordering timer, receive, from NW, a third group of one or more PDUs of a PDU set, and/or transmit a status indication to NW on the PDU set ordering status (e.g., ACK/NACK). If an SN gap is detected between the last PDU of first group and first PDU of the second group, and if the expected SNs (e.g., missing SNs) are not detected in the third group within the reordering timer duration, the WTRU may perform one or more of reordering the PDUs in the second group and third group in ascending order based on the SNs of the PDUs, or delivering the ordered PDUs to upper layers when an end marker is identified. If an SN gap is detected between the last PDU of first group and first PDU of the second group, and if the expected SNs are detected in the third group within the reordering timer duration, the WTRU may resume the ordering of the PDUs in the first and third group and delivers the PDUs to upper layers when an end marker is identified.

A WTRU may include one or more processors. The WTRU may be configured to receive configuration information indicating a re-ordering timer duration. The WTRU may be configured to receive a first plurality of packet data units (PDUs) of a first PDU set. The WTRU may be configured to determine an order of the first plurality of PDUs based on respective sequence numbers (SNs) associated with the first plurality of PDUs. The WTRU may be configured to receive a second plurality of PDUs of a second PDU set. On condition that there is a SN gap between a last received PDU of the first PDU set and a first received PDU of the second PDU set, the WTRU may be further configured to suspend re-ordering of the first plurality of PDUs, set a re-ordering timer to the indicated re-ordering timer duration and start the re-ordering timer, and/or receive a set of one or more additional PDUs while the re-ordering timer is running.

On condition that the set of one or more additional PDUs do not correspond to PDUs associated with the SN gap, the WTRU may be configured to re-order the second plurality of PDUs and the set of one or more additional PDUs based on respective SNs. The WTRU may be configured to deliver the re-ordered second plurality of PDUs and the set of one or more additional PDUs to higher layers.

On condition that the set of one or more additional PDUs correspond to PDUs associated with the SN gap, the WRTU may be configured to resume re-ordering of the first plurality of PDUs and the set of one or more additional PDUs based on respective SNs. The WTRU may be configured to deliver the re-ordered first plurality of PDUs and the set of one or more additional PDUs to higher layers.

The WTRU may be further configured to transmit a status indication on PDU set ordering status to network. The PDU set ordering status may include acknowledgement (ACK) and/or negative acknowledgement (NACK).

The configuration information indicating the re-ordering timer duration may include one or more threshold values associated with the re-ordering timer duration. The order of the first plurality of PDUs may be an ascending order of SNs.

The WTRU may be further configured to start one or more timers upon receiving the first plurality of PDUs of the first PDU set. The one or more timers may start on condition that a first PDU of the first plurality of PDUs is received and/or the re-ordering of the first plurality of PDUs is started. The one or more timers may stop and/or reset on condition that the last PDU of the first plurality of PDUs is received and/or the re-ordering of the first plurality of PDUs is completed.

What is claimed is:

1. A wireless transmit/receive unit (WTRU) comprising a processor configured to:
receive configuration information indicating a reordering timer duration;
receive a first plurality of protocol data units (PDUs) of a first PDU set;
determine an order of the first plurality of PDUs based on respective sequence numbers (SNs) associated with the first plurality of PDUs;
receive a second plurality of PDUs of a second PDU set;
on condition that there is an SN gap between a last received PDU of the first PDU set and a first received PDU of the second PDU set:
suspend reordering of the first plurality of PDUs;
set a reordering timer to the reordering timer duration and start the reordering timer; and
receive a set of one or more additional PDUs while the reordering timer is running.

2. The WTRU of claim 1, wherein the processor is further configured to:
on condition that the set of one or more additional PDUs do not correspond to PDUs associated with the SN gap:
reorder the second plurality of PDUs and the set of one or more additional PDUs based on respective SNs; and
deliver the reordered second plurality of PDUs and the reordered set of one or more additional PDUs to higher layers.

3. The WTRU of claim 1, wherein the processor is further configured to:
on condition that the set of one or more additional PDUs correspond to PDUs associated with the SN gap:
resume reordering of the first plurality of PDUs and the set of one or more additional PDUs based on respective SNs; and
deliver the reordered first plurality of PDUs and the reordered set of one or more additional PDUs to higher layers.

4. The WTRU of claim 1, wherein the processor is further configured to transmit a status indication on PDU set ordering status to a network.

5. The WTRU of claim 4, wherein the PDU set ordering status comprises an acknowledgement (ACK) or a negative acknowledgement (NACK).

6. The WTRU of claim 1, wherein the configuration information indicating the reordering timer duration comprises one or more threshold values associated with the reordering timer duration.

7. The WTRU of claim 1, wherein the order of the first plurality of PDUs is an ascending order based on the respective SNs associated with the first plurality of PDUs.

8. The WTRU of claim 1, wherein the processor is further configured to start one or more timers upon receiving the first plurality of PDUs of the first PDU set.

9. The WTRU of claim 8, wherein the one or more timers start on condition that a first PDU of the first plurality of PDUs is received or the reordering of the first plurality of PDUs is started.

10. The WTRU of claim 8, wherein the one or more timers stop or reset on condition that a last PDU of the first plurality of PDUs is received or the reordering of the first plurality of PDUs is completed.

11. A method comprising:
receiving configuration information indicating a reordering timer duration;
receiving a first plurality of protocol data units (PDUs) of a first PDU set;
determining an order of the first plurality of PDUs based on respective sequence numbers (SNs) associated with the first plurality of PDUs;
receiving a second plurality of PDUs of a second PDU set;
on condition that there is an SN gap between a last received PDU of the first PDU set and a first received PDU of the second PDU set:
suspending reordering of the first plurality of PDUs;
setting a reordering timer to the reordering timer duration and start the reordering timer; and
receiving a set of one or more additional PDUs while the reordering timer is running.

12. The method of claim 11, further comprising:
on condition that the set of one or more additional PDUs do not correspond to PDUs associated with the SN gap:
reordering the second plurality of PDUs and the set of one or more additional PDUs based on respective SNs; and
delivering the reordered second plurality of PDUs and the reordered set of one or more additional PDUs to higher layers.

13. The method of claim 11, further comprising:
on condition that the set of one or more additional PDUs correspond to PDUs associated with the SN gap:
resuming reordering of the first plurality of PDUs and the set of one or more additional PDUs based on respective SNs; and
delivering the reordered first plurality of PDUs and the reordered set of one or more additional PDUs to higher layers.

14. The method of claim 11, further comprising:
transmitting a status indication on PDU set ordering status to a network.

15. The method of claim 14, wherein the PDU set ordering status comprises an acknowledgement (ACK) or a negative acknowledgement (NACK).

16. The method of claim 11, wherein the configuration information indicating the reordering timer duration comprises one or more threshold values associated with the reordering timer duration.

17. The method of claim 11, wherein the order of the first plurality of PDUs is an ascending order based on the respective SNs associated with the first plurality of PDUs.

18. The method of claim 11, further comprising:
starting one or more timers upon receiving the first plurality of PDUs of the first PDU set.

19. The method of claim 18, wherein the one or more timers start on condition that a first PDU of the first plurality of PDUs is received or the reordering of the first plurality of PDUs is started.

20. The method of claim 18, wherein the one or more timers stop or reset on condition that a last PDU of the first plurality of PDUs is received or the reordering of the first plurality of PDUs is completed.
